(19) United States
(12) Patent Application Publication
(10) Pub. No.: US 2025/0262857 A1
(43) Pub. Date: Aug. 21, 2025

(54) Manufacturing Method Of Liquid Ejecting Head

(71) Applicant: SEIKO EPSON CORPORATION, Tokyo (JP)

(72) Inventors: Hiroaki OKUI, Azumino (JP); Shun KATSUIE, Matsumoto (JP); Hirokazu YANAGIHARA, Chino (JP); Ayumi YOKOO, Matsumoto (JP); Yu HASEGAWA, Shiojiri (JP)

(21) Appl. No.: 19/053,601

(22) Filed: Feb. 14, 2025

(30) Foreign Application Priority Data
Feb. 16, 2024 (JP) 2024-022217

(51) Int. Cl. B41J 2/16

(52) U.S. Cl. CPC B41J 2/162; B41J 2/1623

(57) ABSTRACT

In a method of manufacturing a liquid ejecting head including a plurality of head modules each having a chip including at least a nozzle plate in which a plurality of nozzles is formed and a flow path opening forming member, and a holder holding the plurality of head modules, the method includes a first positioning step of optically positioning the nozzle plate and the flow path opening forming member with reference to the nozzles, and a second positioning step of positioning the head module and the holder by press fitting one of a first positioning portion of the flow path opening forming member and a second positioning portion of the holder into the other of first positioning portion and the second positioning portion.

The present application is based on, and claims priority from JP Application Serial Number 2024-022217, filed Feb. 16, 2024, the disclosure of which is hereby incorporated by reference herein in its entirety.

### BACKGROUND

### 1. Technical Field

The present disclosure relates to a method of manufacturing a liquid ejecting head.

### 2. Related Art

A liquid ejecting apparatus including a liquid ejecting head that ejects a liquid such as ink onto a medium such as printing paper has been proposed in the past.

The liquid ejecting head described in JP-A-2022-42753 includes a plurality of head chips (head module), a fixing plate, and a holder. The plurality of head chips is housed in a space enclosed by the fixing plate and the holder. The plurality of head chips is aligned with the fixing plate and fixed to the fixing plate with an adhesive. The fixing plate is fixed to the holder with an adhesive.

When some of a plurality of head modules fail, there is a desire to repair the liquid ejecting head by removing only the failed head modules and replacing them with new head modules.

However, in the previous literature, the fixing plate is required to be removed from the holder when some head modules are to be removed from the holder. This may cause misalignment between a plurality of head modules with the fixing plate as a reference. Hence, it is desirable to be able to easily align a plurality of head modules with each other when repairing and replacing a liquid ejecting head by replacing some of the plurality of head modules included in one liquid ejecting head. Furthermore, it is desired that the alignment between modules of a plurality of heads be performed with high precision not only at the work of replacing the liquid ejecting head, but also at the manufacture of the liquid ejecting head.

### SUMMARY

According to an aspect of the present disclosure, in a method of manufacturing a liquid ejecting head including a plurality of head modules each having a chip including at least a nozzle plate in which a plurality of nozzles is formed and a flow path opening forming member, and a holder holding the plurality of head modules, the method includes a first positioning step of optically positioning the nozzle plate and the flow path opening forming member with reference to the nozzles, and a second positioning step of positioning the head module and the holder by press fitting one of a first positioning portion of the flow path opening forming member and a second positioning portion of the holder into the other of first positioning portion and the second positioning portion.

According to an aspect of the present disclosure, in a method of manufacturing a liquid ejecting head the method including manufacturing a second liquid ejecting head including a second holder, a first liquid ejecting head including a plurality of first head modules and a first holder that holds the plurality of first head modules, the manufacturing including using a portion of the first head module of the first liquid ejecting head, the method includes a press-fit releasing step of releasing a press-fit state in which one of a first positioning portion of the first head module and a second positioning portion of the first holder are press-fitted to the other of the first positioning portion and the second positioning portion, a disassembling step of disassembling the first head module in which the press-fit state with the first holder is released in the press-fit releasing step into a first chip including at least a first nozzle plate in which a plurality of nozzles is formed and a flow path opening forming member including the first positioning portion, a first positioning step of optically positioning a flow path opening forming member separated from the first chip in the disassembling step and a second chip that includes at least a second nozzle plate different from the first nozzle plate, that is, the second nozzle plate and the flow path opening forming member, with nozzles of the second nozzle plate as a reference, and a second positioning step of positioning, by press-fitting one of the first positioning portion of the flow path opening forming member and a second positioning portion of the second holder of a second head module including the second chip and the flow path opening forming member positioned in the first positioning step into the other of the first positioning portion and the second positioning portion, the second head module and the second holder.

### BRIEF DESCRIPTION OF THE DRAWINGS

FIG. 1 is a schematic view of an example configuration of a liquid ejecting apparatus according to the first embodiment.

FIG. 2 is a plan view of a head unit shown in FIG. 1.

FIG. 3 is a cross-sectional view of the liquid ejecting head shown in FIG. 2 viewed along the X axis.

FIG. 4 is a cross-sectional view of the liquid ejecting head shown in FIG. 2 viewed along the Y axis.

FIG. 5 is a bottom view of the liquid ejecting head shown in FIG. 3.

FIG. 6 is a cross-sectional view of the chip of the head module shown in FIG. 3.

FIG. 7 is a top view of the flow path opening forming member of the head module shown in FIG. 4.

FIG. 8 is an enlarged view of the flow path opening forming member shown in FIG. 4.

FIG. 9 is a bottom view of the holder and the relay board shown in FIG. 4.

FIG. 10 is a top view of the holder shown in FIG. 4.

FIG. 11 is a plan view of the lower part of the holder shown in FIG. 4.

FIG. 12 is a top view of the sealing member shown in FIG. 4.

FIG. 13 is a top view of the cover shown in FIG. 4.

FIG. 14 is a flow diagram showing part of the method of manufacturing a liquid ejecting head of the first embodiment.

FIG. 15 is a diagram for describing the first positioning step shown in FIG. 14.

FIG. 16 is a diagram for describing the first positioning step shown in FIG. 14.

FIG. 17 is a diagram for describing the first positioning step shown in FIG. 14.

FIG. 18 is a diagram for describing the second positioning step shown in FIG. 14.

FIG. 19 is a flow diagram showing part of the method of manufacturing a liquid ejecting head of the second embodiment.

FIG. 20 is a diagram for describing the press-fit releasing step shown in FIG. 19.

[FIG. 21 is a diagram for describing the disassembling step shown in FIG. 19.

FIG. 22 is a diagram for describing the first positioning step shown in FIG. 19.

FIG. 23 is a diagram for describing the second positioning step shown in FIG. 19.

FIG. 24 is a cross-sectional view of part of the liquid ejecting head of the first modification.

### DESCRIPTION OF EMBODIMENTS

Hereinafter, preferred embodiments according to the present disclosure will be described with reference to the accompanying drawings. In the drawings, the dimensions or scales of each part are appropriately different from the actual ones, and some parts are schematically shown for easy understanding. Further, the scope of the present disclosure is not limited to these forms unless it is stated in the following description that the present disclosure is particularly limited. “The element β above the element γ” is not limited to a configuration in which the element γ and the element β are in direct contact, but also includes a configuration in which the element γ and the element β are not in direct contact. “The element γ and the element β are equal” means that the elements γ and β is only required to be substantially equal, including a measurement error and a manufacturing error. “The element γ and the element β are the same” means that the element γ and the element β are substantially the same, including a measurement error and a manufacturing error.

### 1. First Embodiment

### 1-1. Overall Configuration of Liquid Ejecting Apparatus 100

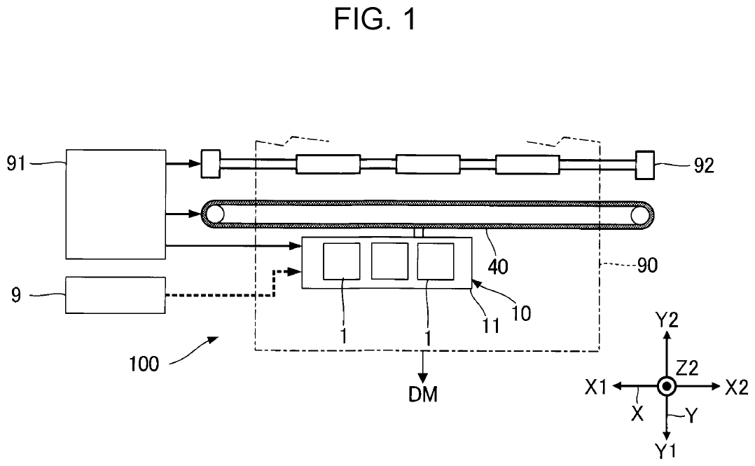

FIG. 1 is a schematic diagram showing the configuration of a liquid ejecting apparatus 100 of the first embodiment. In the following, for convenience of description, the description will be given by appropriately using X axis, Y axis, and Z axis orthogonal to each other. Further, one direction along the X axis is donated as the X1 direction, and a direction opposite to the X1 direction is donated as the X2 direction. Similarly, one direction along the Y axis is denoted as the Y1 direction, and a direction opposite to the Y1 direction is denoted as the Y2 direction. One direction along the Z axis is denoted as the Z1 direction, and a direction opposite to the Z1 direction is denoted as the Z2 direction. The Z1 direction corresponds to “a first direction”. The Z2 direction corresponds to “a second direction, which is opposite to the first direction”. The Z1 direction with respect to a point is referred to as “downward” and the Z2 direction with respect to a point is referred to as “upward”. Viewing in the Z1 direction or the Z2 direction is referred to as “plan view”.

As shown in FIG. 1, the liquid ejecting apparatus 100 includes a liquid storage unit 9, a control unit 91, a transport unit 92, a head unit 10, and a movement mechanism 40.

The liquid storage unit 9 is a container that stores ink. Specific forms of the liquid storage unit 9 include, for example, a cartridge that can be attached to and detached from the liquid ejecting apparatus 100, a bag-shaped ink pack made of flexible film, and an ink tank that can be refilled with ink. The type of ink stored in the liquid storage unit 9 is not limited and is optional.

The control unit 91 controls the operations of respective elements of the liquid ejecting apparatus 100. The control unit 91 includes, for example, a processing circuit such as a central processing unit (CPU) or field programmable gate array (FPGA) and a memory circuit such as semiconductor memory to control the operations of respective elements of the liquid ejecting apparatus 100.

The transport unit 92 transports a medium 90 in a direction DM under control by the control unit 91. The direction DM in the present embodiment is the Y1 direction. In the example shown in FIG. 1, the transport unit 92 includes a long transport roller along the X axis and a motor that rotates the transport roller. The transport unit 92 is not limited to a configuration including the transport roller, but may include, for example, a drum or an endless belt that transports the medium 90 with the medium 90 adsorbed on the outer circumference of the drum or endless belt by electrostatic force or other means.

The movement mechanism 40 includes a transport belt to which a unit base 11 of the head unit 10 is fixed and reciprocably moves the head unit 10 back in the X1 direction and the X2 direction under control by the control unit 91. The head unit 10 ejects, under control by the control unit 91, ink supplied from the liquid storage unit 9 onto the medium 90 in the Z1 direction from each of a plurality of nozzles N. The ejection of ink from the head unit 10 is performed in parallel with the movement of the head unit 10 by the movement mechanism 40 to form an image with ink on the face of the medium 90.

The number and the arrangement of the plurality of liquid ejecting heads 1 of the head unit 10 are not limited to the example shown in FIG. 1, but are any number and any arrangement. When the head unit 10 is configured to be able to circulate ink, the head unit 10 may be coupled to the liquid storage unit 9 via a circulation mechanism for circulating the ink in the head unit 10.

### 1-2. Head Unit 10

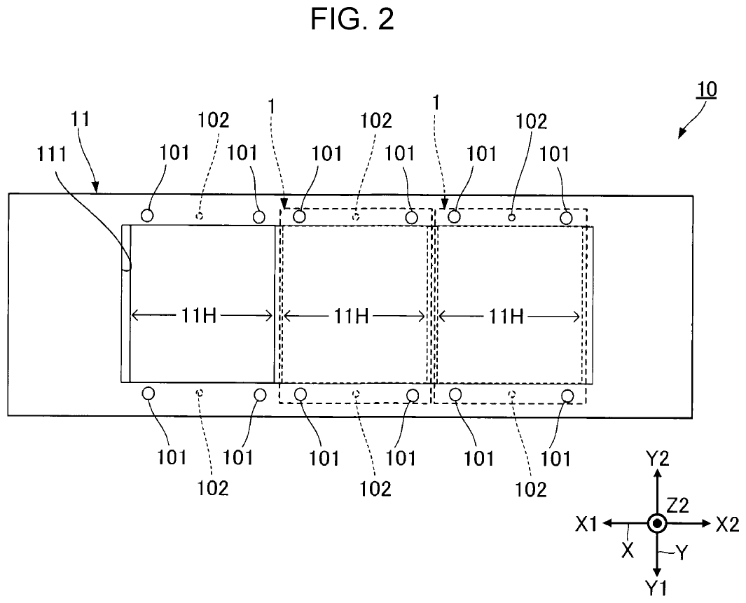

FIG. 2 is a plan view of the head unit 10 shown in FIG. 1. As shown in FIG. 2, the head unit 10 includes the unit base 11 and the plurality of liquid ejecting heads 1. The plurality of liquid ejecting heads 1 is fixed to the unit base 11. The unit base 11 is a component that holds the plurality of liquid ejecting heads 1. In the example shown in the figure, the number of the liquid ejecting heads 1 on the unit base 11 is not limited and can be any number as long as the number is equal to or more than one.

The unit base 11 is, for example, a plate-shaped member with the direction along the Z axis as the thickness direction. The unit base 11 has a recess 111. The recess 111 is a depression in the unit base 11. The bottom of the recess 111 has a plurality of through holes 11H. The planar shape of each through hole 11H is, for example, a rectangle. The through hole 11H is provided for each liquid ejecting head 1. A portion of the liquid ejecting head 1 is inserted into each through hole 11H. In FIG. 2, illustration of several liquid ejecting heads 1 that are disposed at a portion of the unit base 11 are omitted to show the through holes 11H.

The unit base 11 has four mounting holes 101 and two third positioning portions 102 for each through hole 11H. The four mounting holes 101 and the two third positioning portions 102 are provided outside the through hole 11H in plan view. The number and the arrangement of the mounting holes 101 and the third positioning portion 102 are not limited to the example in FIG. 2, but are any number and any arrangement.

Each of the 101 mounting holes is provided, for example, near the four corners of the through hole 11H in plan view. Each of the 101 mounting holes is used to attach the liquid ejecting head 1 to the unit base 11. Each of the 101 mounting holes, for example, penetrates the unit base 11 in the thickness direction.

Each third positioning portion 102 is provided, for example, between two mounting holes 101 aligned in the direction along the X axis and is away from the two mounting holes. Each third positioning portion 102 is used to position the unit base 11 of the liquid ejecting head 1. Each third positioning portion 102 is, for example, a bottomed hole opening in the face of the unit base 11 in the Z1 direction. Each third positioning portion 102 can be said to be a recess formed in the face of the unit base 11 in the Z1 direction.

Each of the mounting holes 101 does not have to penetrate the unit base 11 in the thickness direction. Each third positioning portion 102 may penetrate the unit base 11 in the thickness direction. The shape of the unit base 11 is not limited to a plate shape, but can be box-shaped, for example.

### 1-3. Liquid Ejecting Head 1

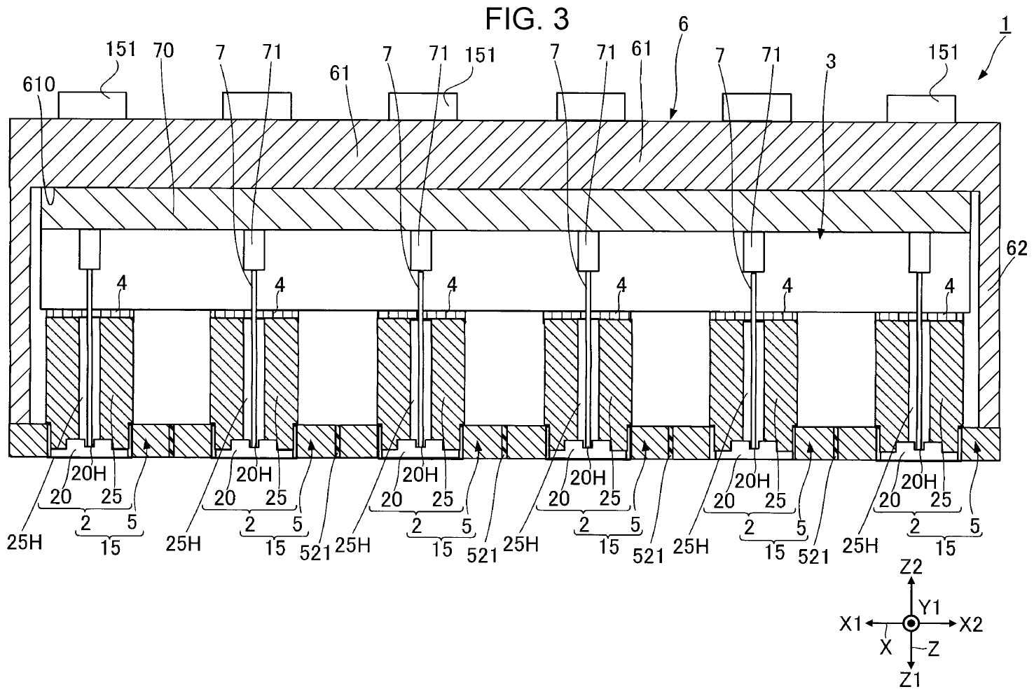

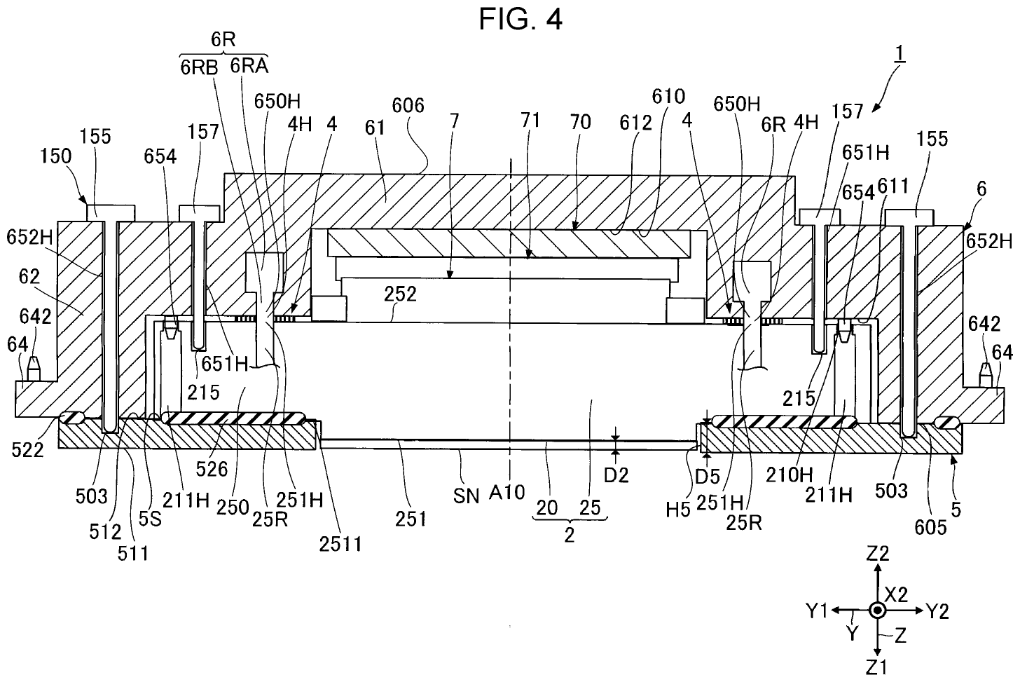

FIG. 3 is a cross-sectional view of the liquid ejecting head 1 shown in FIG. 2, viewed along the X axis. FIG. 4 is a cross-sectional view of the liquid ejecting head 1 shown in FIG. 2, viewed along the Y axis. As shown in FIG. 4, the liquid ejecting head 1 in the present embodiment has a configuration that is almost symmetrical about a central virtual plane A10 along the X-Z plane. The liquid ejecting head 1 may not have a configuration that is symmetrical about the central virtual plane A10.

As shown in either FIG. 3 or FIG. 4, the liquid ejecting head 1 includes a plurality of head modules 2, a sealing member 4, a plurality of covers 5, a holder 6, a plurality of circuit boards 7, and a relay board 70.

In the liquid ejecting head 1, the cover 5, the holder 6, and the plurality of head modules 2 are removable from each other. After removing the cover 5 from the holder 6, each head module 2 can be removed individually from the holder 6. Each head module 2 can be individually removed from the holder 6.

Hence, for example, when some of the plurality of head modules 2 included in the head unit 10 are broken, the liquid ejecting head 1 can be reused by replacing a subunit 15 including the broken head module 2 with another subunit 15 including the head module 2 that has not broken.

Although it is preferable that the cover 5 and the plurality of head modules 2 is fixed with an adhesive, the head module 2 may be configured to be removable from the cover 5 by removing the adhesive.

### 1-3A. Head Module 2

In the example in FIG. 3, the plurality of head module 2 includes six head modules 2. The number of the head modules 2 is not limited to six, but may be equal to or more than one and equal to or less than five, or equal to or more than seven.

In the present embodiment, the plurality of head modules 2 is disposed along the X axis. As shown in FIG. 4, each head module 2 is long along the Y axis. Each head module 2 ejects ink in the Z1 direction. The head module 2 includes a chip 20 and a flow path opening forming member 25. The chip 20 is positioned in the Z1 direction with respect to the flow path opening forming member 25.

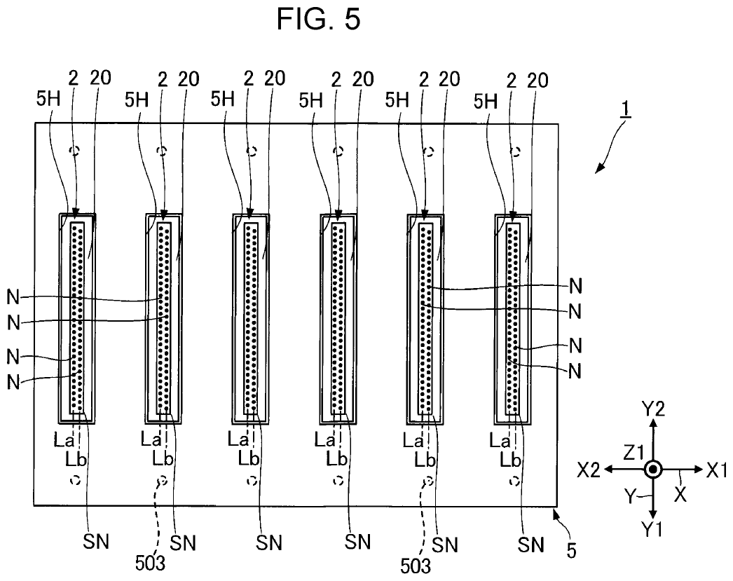

FIG. 5 is a bottom view of the liquid ejecting head 1 shown in FIG. 3. As shown in FIG. 5, each head module 2 includes a plurality of nozzles N through which ink is ejected. The plurality of nozzles N is disposed along the Y axis. The plurality of nozzles N is divided into a nozzle row La and a nozzle row Lb that are mutually spaced in the X axis. Each of the nozzle row La and the nozzle row Lb is a set of a plurality of nozzles N disposed in a linear array in the Y axis. The face of the head module 2 in which openings of a plurality of nozzle N are formed is a nozzle face SN. The nozzle face SN is a face of the chip 20 of the head module 2, the face facing the Z1 direction. For example, the plurality of nozzles N may be disposed in a direction that intersects the X and Y axes when viewing the Z1 direction.

1-3Aa. Chip 20

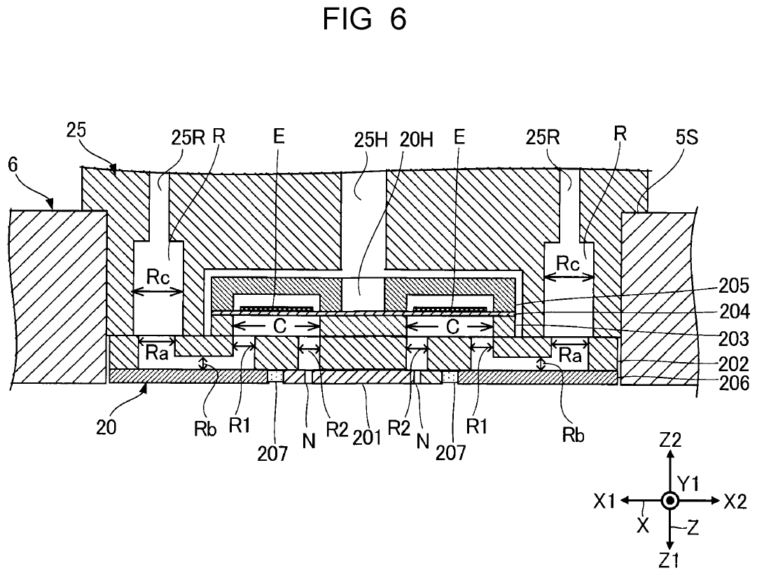

FIG. 6 shows a cross-sectional view of the chip 20 of the head module 2 shown in FIG. 3. The chip 20 has a structure in which the element associated with each nozzle N in the nozzle row La and the element associated with each nozzle N in the nozzle row Lb are disposed in a generally plane symmetrical manner. In the following description, emphasis will be placed on the elements corresponding to nozzle row La, and description of the elements corresponding to the nozzle row Lb will be omitted where appropriate. In the following, when the nozzle row La and the nozzle row Lb are not distinguished, they are referred to as a nozzle row L.

As shown in FIG. 6, the chip 20 of each head module 2 includes, for example, a communication plate 202, a pressure chamber substrate 203, a vibration plate 204, a nozzle plate 201, a cover 206, a plurality of drive elements E, and a sealing substrate 205.

Each of the communication plate 202, the pressure chamber substrate 203, the vibration plate 204, the nozzle plate 201, and the cover 206 is a long plate-like member in the Y axis. The pressure chamber substrate 203 is installed on the face of the communication plate 202 in the Z2 direction. The nozzle plate 201 and cover 206 are installed on the face of the communication plate 202 in the z1 direction. For example, the components are fixed to each other with an adhesive.

The nozzle plate 201 is a plate-like member with a plurality of nozzles N formed. The nozzle plate 201 is a member of the head module 2, the member being located in the most Z1 direction. The face, of the nozzle plate 201, that faces the Z1 direction is the nozzle face SN. Each of the plurality of nozzles N is a circular through hole through which ink is ejects. For example, the nozzle plate 201 is fabricated by processing a single-crystal substrate of silicon (Si) using semiconductor manufacturing techniques such as photolithography and etching.

The communication plate 202 has a plurality of apertures R1 and a plurality of communication flow paths R2, a communication space Ra, and a common flow path Rb. Each of the apertures R1 and each of the communication flow path R2 are through holes that extend in the Z1 direction and are formed for each nozzle N. The communication flow path R2 overlaps the nozzle N in plan view. The communication space Ra is a long-shaped opening in the Y axis. The communication space Ra extends in the Y axis. The common flow path Rb communicates with the communication space Ra and overlaps the communication space Ra in plan view. The common flow path Rb extends in the Y axis. The common flow path Rb communicates with the plurality of apertures R1. The communication space Ra communicates with a space Rc that the flow path opening forming member 25 has.

The communication space Ra, the common flow path Rb, and the space Rc form a common space R communicating with a plurality of nozzles N. The common space R serves as an ink reservoir. Ink stored in the common space R is supplied into a plurality of pressure chambers C in parallel by branching into each aperture R1 and the chambers are filled with the ink.

The pressure chamber substrate 203 has a plurality of pressure chambers C. The pressure chamber C is a space located between the communication plate 202 and the vibration plate 204 and formed by the walls of the pressure chamber substrate 203. The pressure chamber C is formed for each nozzle N. The pressure chamber C is a long space extending in the X1 direction. The plurality of pressure chambers C is disposed in the Y axis.

The communication plate 202 and pressure chamber substrate 203 are manufactured by machining a semiconductor substrate, such as a single-crystal substrate of silicon, for example.

The elastically deformable vibration plate 204 is disposed above the pressure chamber C. The vibration plate 204 is stacked on the pressure chamber substrate 203 and contacts a surface of the pressure chamber substrate 203, the surface being opposite to the communication plate 202. The vibration plate 204 is a long rectangular plate-like member in the Y axis in plan view. The pressure chamber C communicates with the communication flow path R2 and the aperture R1. Therefore, the pressure chamber C communicates with the nozzle N via the communication flow path R2 and communicates with the communication space Ra via the aperture R1. The nozzle N, the communication flow path R2, the pressure chamber C, and the aperture section R1 form an individual flow path for each nozzle N. In FIG. 6, the pressure chamber substrate 203 and the vibration plate 204 are shown as separate substrates for ease of explanation, but they are actually stacked on one silicon substrate.

The drive element E is formed on the face, of the vibration plate 204, opposite the pressure chamber C, for each pressure chamber C. The drive element E is a long piezoelectric element in the X axis in plan view. The drive element E includes, for example, a pair of electrodes and a piezoelectric material sandwiched between the pair of electrodes. The drive element E may be an electrothermal conversion element that generates thermal energy.

The sealing substrate 205 is a structure that protects the plurality of drive elements E. The sealing substrate 205 is fixed to the surface of the vibration plate 204 with, for example, an adhesive. The plurality of drive elements E is housed inside a recess formed at a face of the sealing substrate 205, the face being opposite to the vibration plate 204. In addition, the sealing substrate 205 has a wiring hole 20H for inserting the circuit board 7 described below.

The cover 206 is a thin metal plate that constitutes the wall face of the common flow path Rb. The cover 206 has a thickness similar to the nozzle plate 201. The planar shape of the cover 206 is, for example, a frame surrounding the nozzle plate 201. A mold 207 made of resin is provided between the cover 206 and the nozzle plate 201. The face, of the cover 206, that faces the Z1 direction constitutes part of the nozzle face SN.

In such a chip 20, when the drive element E contracts due to energization, the vibration plate 204 bends and flexes in the direction in which the volume of the pressure chamber C decreases, and the pressure in the pressure chamber C increases, causing ink droplets to be ejected from the nozzle N. At this time, pressure propagates from the pressure chamber C to the aperture R1, and ink flows into the common flow path Rb through the aperture R1. After ink is ejected, the drive element E is restored to its original position. In this case, the ink from nozzle N to the common flow path Rb vibrates. Then, the ink is supplied from the aperture R1 at the same time when the meniscus of nozzle N is restored. Through the above series of operations, the ink is ejected from nozzle N.

In the preceding description, the chip 20 includes each of the components shown in FIG. 6, but the chip 20 is not required to have all of the components described above, and may have an additional component.

The chip 20 is, for example, a component that has a monolithic structure and is thinner than the flow path opening forming member 25, for example, less than 3000 μm thick. The chip 20 may have a thickness of 1500 μm or less, or 1000 μm or less. The chip 20 may have a thickness of ⅕ or less of the length of the short side of the chip 20 viewed in the direction of the thickness of the chip 20. Furthermore, the chip 20 is only required to include at least the nozzle plate 201, includes more preferably the pressure chamber substrate 203, and includes especially preferably the communication plate 202. At least one of the nozzle plate 201, the pressure chamber substrate 203, the communication plate 202 or the drive element E, and the sealing substrate 205 may be regarded the chip 20. The chip 20 may be a laminate of thin sheets of ceramic or metal or a laminate of thin sheet members of the aforementioned materials, as well as a laminate of silicon substrates manufactured by MEMS.

1-3A b. Flow Path Opening Forming Member 25

As shown in FIGS. 4 and 6, the flow path opening forming member 25 is disposed in the Z2 direction of the chip 20. The flow path opening forming member 25 and the chip 20 are fixed to each other with, for example, an adhesives. The flow path opening forming member 25 has, for example, a flow path that supplies ink to the chip 20.

The flow path opening forming member 25 is, for example, preferably a member with a thickness of 3000 μm or more, preferably a member with a thickness of 5000 μm or more, and preferably a member with a thickness of 8000 μm or more. The flow path opening forming member 25 may be formed of one member or a laminate of a plurality of members.

The flow path opening forming member 25 is made of metal, but may be made of resin. The flow path opening forming member 25 is made of resin such as thermosetting resin, which allows for lower cost. However, when the flow path opening forming member 25 is made of metal, it is easy to reuse the flow path opening forming member 25 when the head module 2 is replaced. Hence, it is easier to repeatedly use the flow path opening forming member 25 than when the flow path opening forming member is made of resin. In addition, the metal material allows for positioning of the flow path opening forming member 25 with high precision with respect to the holder 6, compared with when the flow path opening forming member is made of resin.

As shown in FIG. 4, the length, or the thickness, of the flow path opening forming member 25 in the direction in the Z axis is thicker than a thickness D2 of the chip 20. The thickness of the flow path opening forming member 25 here is a thickness at the position where the flow path opening forming member overlaps a seal region 4S described below when viewing the Z1 direction. In other words, the chip 20 is thinner than the flow path opening forming member 25. The flow path opening forming member 25 has a face 251 that faces the Z1 direction and a face 252 that faces the Z2 direction.

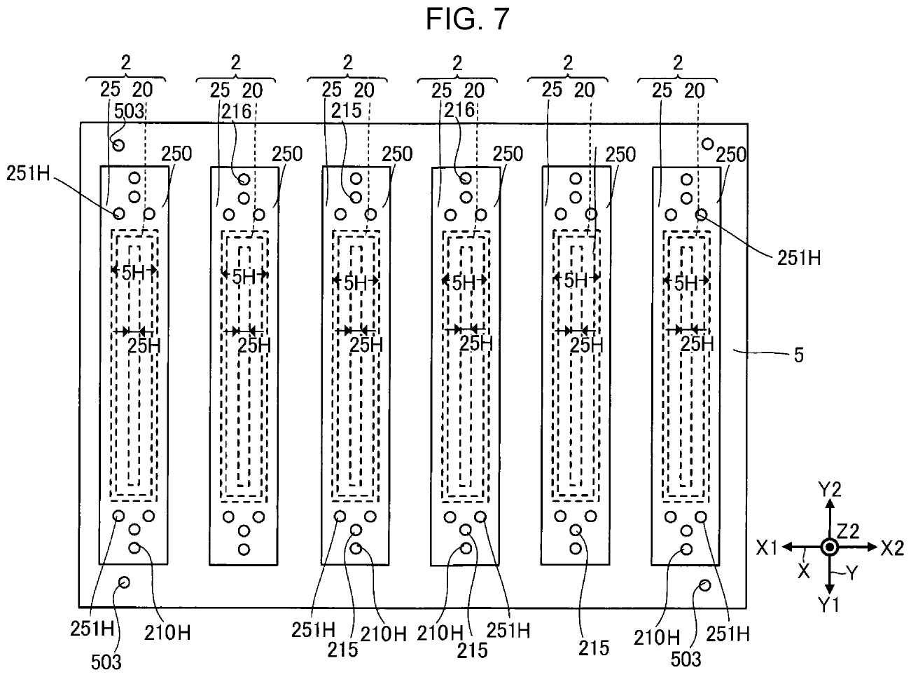

FIG. 7 is a top view of the flow path opening forming member 25 of the head module 2 shown in FIG. 4. As shown in FIG. 7, the planar shape of the flow path opening forming member 25 is larger than the planar shape of the chip 20. In other words, the chip 20 has a smaller outer shape than the flow path opening forming member 25 when viewing the Z1 direction. The flow path opening forming member 25 overlaps the chip 20 and covers the chip 20 when viewing the Z1 direction.

As shown in FIGS. 4 and 7, the flow path opening forming member 25 includes a flange 250 for fixing to the cover 5, described below. The planar shape of the flange 250 is a rectangular frame that surrounds an opening 5H of the cover 5 described below. As shown in FIG. 4, the face, of the flange 250, that faces the Z1 direction is a supported face 2511 that is supported by the cover 5 described below. Since the planar shape of the flange 250 is a rectangular frame surrounding the opening 5H, the planar shape of the supported face 2511 is also a rectangular frame surrounding the opening 5H. The supported face 2511 is located in the Z2 direction of the chip 20. Therefore, the supported face 2511 is located in the Z2 direction of the nozzle plate 201.

As shown in FIG. 7, the flow path opening forming member 25 has a wiring hole 25H. The circuit board 7 (described below) is inserted into the wiring hole 25H. The wiring hole 25H is provided at the center of the flow path opening forming member 25 in plan view. Referring to FIG. 6, the wiring hole 25H overlaps the wiring hole 20H of the sealing substrate 205 in plan view.

As shown in FIGS. 4 and 6, the flow path opening forming member 25 has a flow path 25R therein. The flow path 25R is provided to supply ink to the chip 20. As shown in FIG. 6, the space Rc is provided close to the chip 20 in the flow path 25R, or downstream of the flow path 25R. The flow path 25R communicates with the space Rc.

As shown in FIG. 4, a plurality of flow path openings 251H is provided in the flow path 25R that the flow path opening forming member 25 has, the openings being opposite to the chip 20, that is, being located upstream. Each flow path opening 251H is an opening end of the flow path 25R in the Z2 direction. The flow path opening 251H is an opening for flow-path-communicating the flow path 25R that the flow path opening forming member 25 of the head module 2 has with a flow path 6R of the holder 6 described below. As shown in FIGS. 4 and 7, the plurality of flow path openings 251H is provided in the flange 250 of the flow path opening forming member 25. The flow path opening 251H is located outside of the chip 20 when viewing the Z1 direction. In the present embodiment, two flow path openings 251H are provided for each nozzle row L.

As shown in FIGS. 4 and 7, each flow path opening forming member 25 has two fixing holes 215. The head module 2, including the flow path opening forming member 25, can be attached to and detached from the holder 6. Each of the 215 fixing holes is used for fixing the head module 2 to the holder 6.

Each fixing hole 215 is provided in the face 252, of the flow path opening forming member 25, that faces the Z2 direction. Each fixing hole 215 has a bottomed hole opening in the face 252, of the flow path opening forming member 25, that faces the Z2 direction. Each fixing hole 215 is a recess in the face 252, of the flow path opening forming member 25, that faces the Z2 direction, that can be regarded as a depression formed in the face 252. One of the two fixing holes 215 is located in the Y1 direction of the chip 20 and the other is located in the Y2 direction of the chip 20 when viewing the Z1 direction.

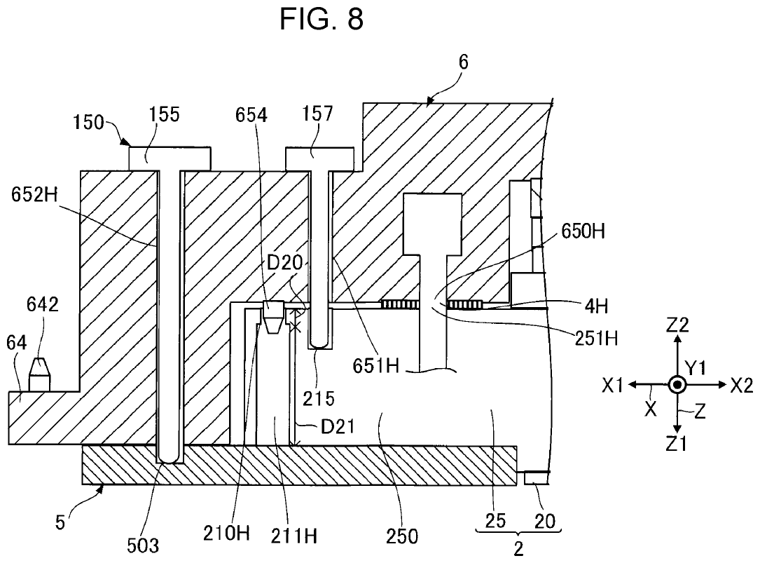

FIG. 8 is an enlarged view of the flow path opening forming member 25 shown in FIG. 4. In FIG. 8, illustration of bushings 522 and 526, described below, is omitted.

As shown in FIG. 8, each flow path opening forming member 25 has a first positioning portion 210H and a through hole 211H. The first positioning portion 210H and the through hole 211H constitute a hole penetrating the flow path opening forming member 25 in the thickness direction. Each of the first positioning portion 210H and the through hole 211H is used for positioning the head module 2 to the holder 6, and the like. Specifically, the first positioning portion 210H is a positioning hole for positioning the head module 2 to the holder 6 and corresponds to a second positioning portion 654 described below.

The first positioning portion 210H and the through hole 211H are aligned along the Z axis and communicate with each other. The through hole 211H is located in the Z1 direction of the first positioning portion 210H. The face 251, of the flow path opening forming member 25, that faces the Z1 direction has the through hole 211H, specifically the opening end of the through hole 211H. The face 252, of the flow path opening forming member 25, that faces the Z2 direction has the first positioning portion 210H, specifically the open end of the first positioning portion 210H.

In the present embodiment, the opening area of the through hole 211H is larger than the opening area of the first positioning portion 210H. In other words, the outer diameter of the through hole 211H is larger than the outer diameter of the first positioning portion 210H. The opening area of the through hole 211H may be less than or equal to the opening area of the first positioning portion 210H. The length of the through hole 211H along the Z axis, or a depth D21, is greater than a depth D20 of the first positioning portion 210H. The depth D21 may be less than or equal to the depth D20. The width and the opening area of the through hole 211H are constant, but may not be constant. Similarly, the width and the opening area of the first positioning portion 210H are constant, but may not be constant.

As shown in FIG. 7, each flow path opening forming member 25 has two first positioning portions 210H. For this purpose, each flow path opening forming member 25 has two through holes 211H. As shown in FIG. 7, one of the two first positioning portions 210H is located in the Y1 direction of the chip 20 and the other is located in the Y2 direction of the chip 20 when viewing the Z1 direction.

In the example in FIG. 7, the shortest distance between the chip 20 and the fixing hole 215 is shorter than the shortest distance between the chip 20 and the first positioning portion 210H when viewing the Z1 direction, but may be longer. The first positioning portion 210H, the fixing hole 215 and the opening 5H are aligned along the longitudinal direction of the cover 5, but may not be aligned. For example, the first positioning portions 210H may be provided on both sides of the opening 5H in the X axis.

### 1-3B. Holder 6

As shown in FIGS. 3 and 4, the holder 6 holds and houses the plurality of head modules 2 and has a common flow path that supplies and distributes ink to the plurality of head modules 2. The holder 6 is common to the plurality of head modules 2.

As shown in FIG. 4, the holder 6 has one flow path 6R. The flow path 6R supplies ink to the respective head modules 2 and distributes the ink to the respective head module 2. The flow path 6R is a common flow path shared by the plurality of head modules 2, and has a common portion 6RA extending in the X axis and a plurality of branch portions 6RB branching from the common portion 6RA and extending in the Z1 direction. Although not shown in the figure, the holder 6 includes a flow path joint to communicate with the supply flow path outside the liquid ejecting head 1 for communicating with the liquid storage unit 9. This flow path joint (not shown) is exposed to the outside of the liquid ejecting head 1, for example, through an opening (not shown) in the holder 6.

The holder 6 may have the plurality of flow paths 6R that communicates with the plurality of head modules 2. In other words, the flow path 6R may have a configuration that does not include the common portion 6RA that communicates with the plurality of head modules 2, but includes a plurality of flow paths 6R that communicates with the plurality of head modules 2.

The flow path 6R has a flow path opening 650H close to the head module 2 or downstream thereof. The flow path opening 650H is an opening end of the flow path 6R in the Z1 direction. The flow path opening 650H is provided corresponding to the flow path opening 251H that the head module 2 has. The flow path opening 650H is an opening for flow-path-communicating the flow path 25R of the head module 2 with the flow path 6R of the holder 6.

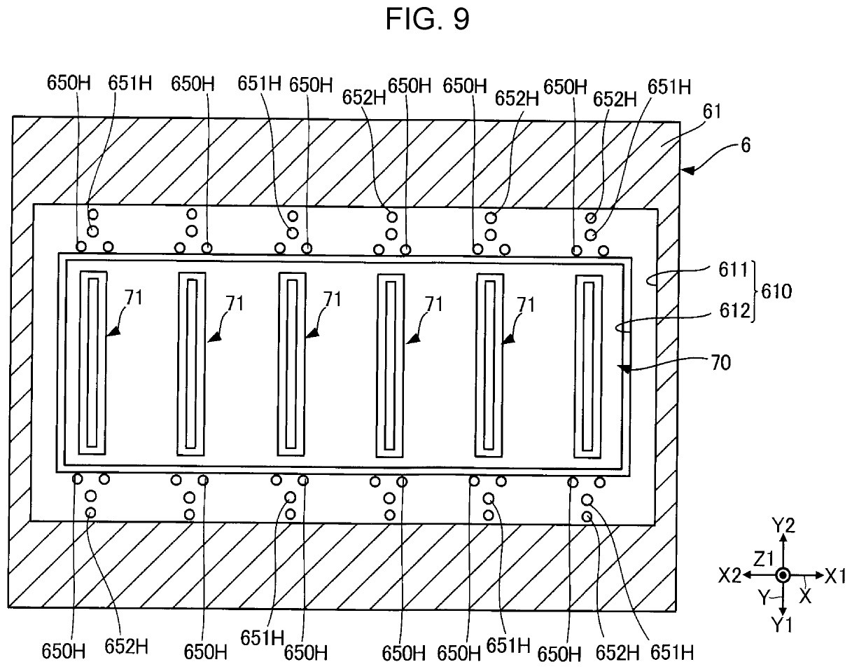

FIG. 9 is a bottom view of the holder 6 and the relay board 70 shown in FIG. 4. As shown in FIGS. 3, 4 and 9, the holder 6 is box-shaped, having a recess 610 opening in the Z1 direction. The plurality of head modules 2 is disposed in the housing space in the recess 610 of the holder 6. It can be taken that the holder 6 and the cover 5 described below form the housing space for the plurality of head modules 2. The holder 6 includes metals such as aluminum or stainless steel, for example.

As shown in FIGS. 4 and 9, the recess 610 includes a first recess 611 and a second recess 612. As shown in FIG. 4, the bottom of the first recess 611 has the second recess 612. The first recess 611 is located in the Z1 direction of the center of the holder 6 in the Z axis. The second recess 612 is located in the Z2 direction of the center of the holder 6 in the Z axis. The opening area of the second recess 612 is smaller than the opening area of the first recess 611. Thus, the recess 610 has a stepped face.

The relay board 70 is bonded to the bottom of the recess 610, specifically the bottom of the second recess 612, for example with an adhesive. Although not shown in detail, the holder 6 has an opening for inserting a wiring member external to the liquid ejecting head 1 for electrically coupling the relay board 70 and the control unit 91.

As shown in FIG. 3, the holder 6 includes a flat plate portion 61, a side wall 62, and two flanges 64. The flat plate portion 61, the side wall 62, and the two flanges 64 are formed as one piece.

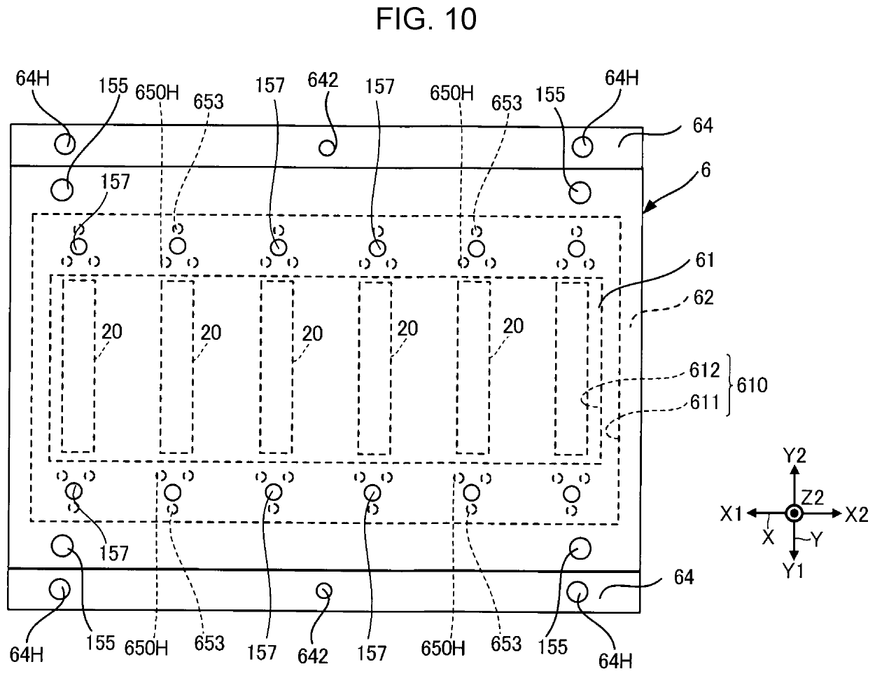

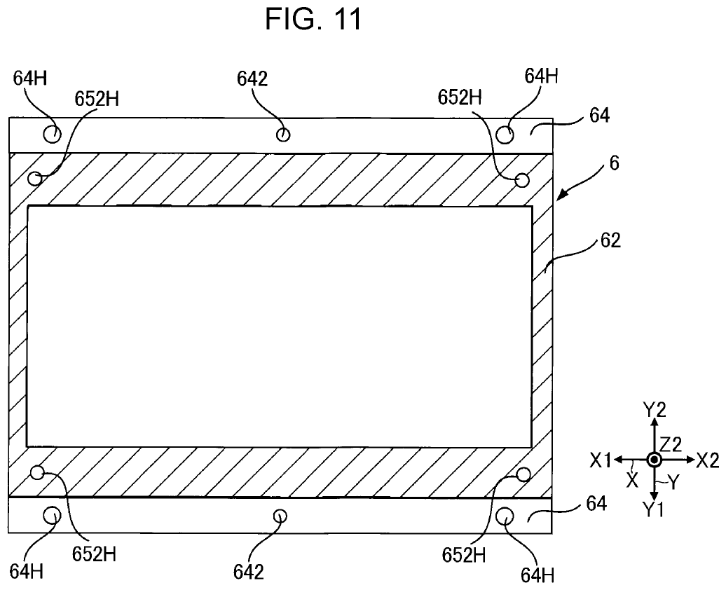

FIG. 10 is a top view of the holder 6 shown in FIG. 3. FIG. 11 is a plan view of the lower part of the holder 6 shown in FIG. 3. As shown in FIG. 3, 4 or 10, the flat plate portion 61 is a flat section along the X-Y plane and is located in the Z2 direction of the plurality of head modules 2. The side wall 62 is a portion extending in the Z1 direction from the outer edge of the flat plate portion 61. The planar shape of the side wall 62 is a rectangular frame. The inner wall face of the side wall 62 has the aforementioned stepped face.

As shown in FIG. 4, the holder 6 has a plurality of fixing holes 651H, a plurality of fixing holes 652H, and the plurality of second positioning portions 654. Each fixing hole 651H is used to fix the holder 6 and the head module 2. Each of the 652H fixing holes is used to fix the holder 6 and the cover 5. Each second positioning portion 654 is used for positioning the head module 2 to the holder 6.

Each fixing hole 651H is a hole penetrating the holder 6 in the Z1 direction. Two fixing holes 651H are provided for each head module 2. Each fixing hole 651H is provided in the Y1 direction or the Y2 direction of the second recess 612 when viewing the Z1 direction. The two fixing holes 651H are provided corresponding to the two fixing holes 215 described above and overlap the two fixing holes 215 when viewing the Z1 direction. Each fixing hole 651H does not overlap the chip 20 when viewing the Z1 direction, but overlaps the flow path opening forming member 25. The opening end of each fixing hole 651H in the Z1 direction opens at the bottom of the first recess 611.

Each fixing hole 652H is a hole penetrating the holder 6 in the Z1 direction. As shown in FIG. 11, the plurality of fixing holes 652H includes, for example, four fixing holes 652H, and the fixing holes 652H are provided at the four corners of the square holder 6 when viewing the Z1 direction. Each fixing hole 652H does not overlap the recess 610 when viewing the Z1 direction.

Each second positioning portion 654 is a projection on a face 605, of the holder 6, that faces the Z1 direction, specifically on the bottom of the first recess 611. More specifically, each second positioning portion 654 is a positioning pin protruding from the first recess 611 in the Z1 direction. In the present embodiment, the two second positioning portions 654 are provided for each head module 2. The two second positioning portions 654 are provided corresponding to the two first positioning portions 210H described above and overlap the two first positioning portions 210H when viewing the Z1 direction. Thus, the plurality of second positioning portions 654 correspond to the plurality of first positioning portions 210H on a one-to-one basis.

Of the fixing hole 651H, the second positioning portion 654, and the fixing hole 652H, the fixing hole 651H is closest to the chip 20 and the fixing hole 652H is farthest from the chip 20 when viewing the Z1 direction. The distance between the fixing hole 651H and the chip 20, the distance between the second positioning portion 654 and the chip 20, and the distance between the fixing hole 652H, and the chip 20 when viewing the Z1 direction may be the same or different.

Each second positioning portion 654 is press-fit into the aforementioned first positioning portion 210H to position the cover 5 to the holder 6. With the first positioning portion 210H and the second positioning portion 654 being provided, the head module 2 can be easily positioned when attached to the holder 6.

In addition, the simple method of press-fitting the first positioning portion 210H into the second positioning portion 654 allows alignment between the plurality of head modules 2 with high precision. This makes it easy to replace a desired head module 2 of the plurality of head modules 2. Hence, it is possible to replace the head module 2 by unit, thus facilitating repair of the liquid ejecting head 1.

Furthermore, the first positioning portion 210H and the second positioning portion 654 are provided in units of the head module 2. The first positioning portion 210H and the second positioning portion 654 are provided for each head module 2, enabling alignment between the plurality of head modules 2 with high precision. Therefore, when replacing only some of the plurality of head modules 2, there is no need to re-align all the head modules 2.

As shown in FIG. 4, the holder 6 has a plurality of fourth positioning portions 642. As shown in FIG. 4, the fourth positioning portion 642 is a projection protruding toward the 22 direction from the face, of the flange 64 of the holder 6, in the Z2 direction. The plurality of fourth positioning portions 642 is provided in correspondence with the plurality of third positioning portions 102 of the unit base 11 shown in FIG. 2 on a one-to-one basis.

The fourth positioning portion 642 is press-fit into one of the plurality of third positioning portions 102 on the unit base 11 to position the liquid ejecting head 1 in relation to the unit base 11. This allows for more accurate alignment between the plurality of liquid ejecting heads 1 with respect to the unit base 11.

As shown in FIG. 10, the flange 64 has a mounting hole 64H. The mounting hole 64H corresponds to the mounting hole 101 of the unit base 11. For example, the flange 64 and the unit base 11 are fixed by inserting screws or the like (not shown) into the mounting hole 64H and the mounting hole 101 in this order, and then screwing them in place. As a result, the liquid ejecting head 1 is fixed to the unit base 11.

### 1-3C. Sealing Member 4

As shown in FIGS. 3 and 4, the sealing member 4 is provided between each head module 2 and the holder 6 in the Z1 direction. The sealing member 4 is provided for each head module 2. The sealing member 4 is elastic. In the present embodiment where the sealing member 4 is an elastic material such as an elastomer, the length, or the thickness, of the sealing member 4 in the Z axis is constant. The thickness of the sealing member 4 is thinner than the thickness of each of the flow path opening forming member 25 and the holder 6. The sealing member 4 is press-collapsed by the head module 2 and the holder 6.

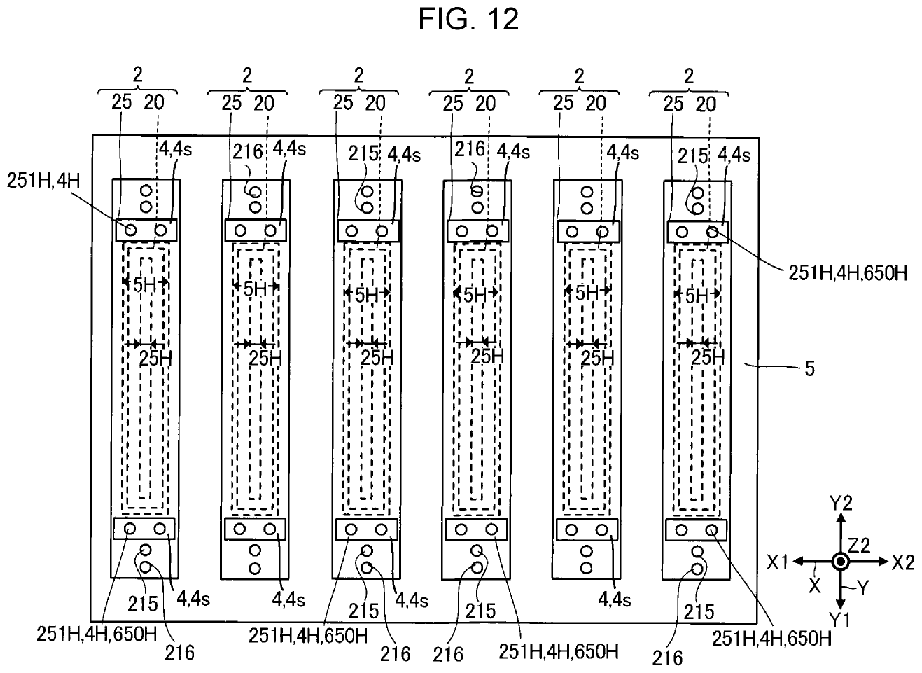

FIG. 12 is a top view of the sealing member 4 shown in FIG. 4. In the example shown in FIG. 12, two sealing members 4 are provided for each head module 2. The two sealing members 4 are provided at both ends of one head module 2 in the longitudinal direction. Each sealing member 4 is a rectangle when viewing the Z1 direction. Each sealing member 4 overlaps the flange 250 of the flow path opening forming member 25 of the head module 2 when viewing the Z1 direction. On the other hand, in the present embodiment, the sealing member 4 is provided at a position different from that of the chip 20 when viewing the Z1 direction. In other words, the sealing member 4 does not overlap the chip 20 when viewing the Z1 direction.

As shown in FIGS. 4 and 12, each sealing member 4 has two communication ports 4H. As shown in FIG. 4, each communication port 4H is provided corresponding to one flow path opening 251H of the flow path opening forming member 25 and one flow path opening 650H of the holder 6. As shown in FIG. 12, the communication ports 4H overlap each of the flow path openings 650H and the flow path opening 251H when viewing the Z1 direction. As shown in FIG. 4, the communication port 4H communicates with the flow path 25R via the flow path opening 251H. The communication port 4H communicates with the flow path 6R via the flow path opening 650H. Therefore, the flow path 25R communicates with the flow path 6R through the communication port 4H. Specifically, the flow path 25R and the flow path 6R communicate with each other through the communication port 4H by press-collapsing the sealing member 4 between the flow path opening forming member 25 and the holder 6.

Such a sealing member 4 is a member that liquid-tightly communicates the flow path opening 251H of the head module 2 with the flow path opening 650H of the holder 6. Ink flowing in the flow path 6R of the holder 6 flows to the flow path 25R of the flow path opening forming member 25 through the communication port 4H and is supplied to the individual flow paths of the chip 20 through the common space R.

As shown in FIG. 12, the sealing member 4 has the seal region 4S. In the present embodiment, the entire region of the sealing member 4 corresponds to the seal region 4S. The seal region 4S is in contact with both the flow path opening forming member 25 and the holder 6, and is a region, of the sealing member 4, that is sandwiched between the flow path opening forming member 25 and the holder 6. The seal region 4S is a region where the sealing member is collapsed under load from the flow path opening forming member 25 and the holder 6 in order to cause the flow path opening 251H and the flow path opening 650H liquid-tightly communicate with each other. In other words, a region, of the sealing member 4, that is sandwiched between both the flow path opening forming member 25 and the holder 6, but is not collapsed under load from both members and does not contribute to cause the flow path opening 251H and the flow path opening 650H substantially liquid-tightly communicate with each other, is not included in the seal region 4S.

As shown in FIG. 12, the seal region 4S is provided at a position different from that of the chip 20 when viewing the Z1 direction because the sealing member 4 is provided at a position different from that of the chip 20 when viewing the Z1 direction. In other words, the seal region 4S does not overlap the chip 20 when viewing the Z1 direction. The seal region 4S does not overlap the chip 20 when viewing the Z1 direction, so that it is unlikely that influence of the reaction force of the sealing member 4 acts on the chip 20, compared with the case where the seal region overlaps the chip. This improves the reliability of the head module 2.

The seal region 4S is located in the Y1 direction or the Y2 direction, which is the longitudinal direction of the head module 2, from the chip 20, when viewing the Z1 direction. The seal region 4S is located in the longitudinal direction of the chip 20, so that it is possible to avoid the seal region 4S from being located between adjacent chips 20. Therefore, the seal region 4S is provided, so that it is possible to avoid the distance between adjacent chips 20 from increasing. Therefore, print quality is not easily affected.

The seal region 4S may be provided in the direction in which the plurality of head modules 2 is aligned with respect to the chip 20, that is, in the short direction of the head module 2. The sealing member 4 may be provided in the direction in which the plurality of head modules 2 is aligned with respect to the chip 20, that is, in the short direction of the head modules 2.

### 1-3D. Cover 5

The cover 5, shown in FIGS. 3 and 4, is a support member that supports the plurality of head module 2. The cover 5 is common to the plurality of head modules 2, but may be provided individually for each head module 2. The cover 5 is a plate-shaped member with the direction in the Z axis as the thickness direction. The cover 5 is positioned in the Z1 direction of the plurality of flow path opening forming members 25. The cover 5 is a member for sandwiching the sealing member 4 and the flow path opening forming member 25 between the cover and the holder 6. As shown in FIG. 4, the cover 5 has a face 511 that faces the Z1 direction and a face 512 that faces the Z2 direction. The cover 5 is a member that does not have a flow path through which ink flows.

The cover 5 is made of metal, for example. The cover 5 includes metals such as aluminum and stainless steel, for example. The cover 5 is rigid to support the plurality of head module 2.

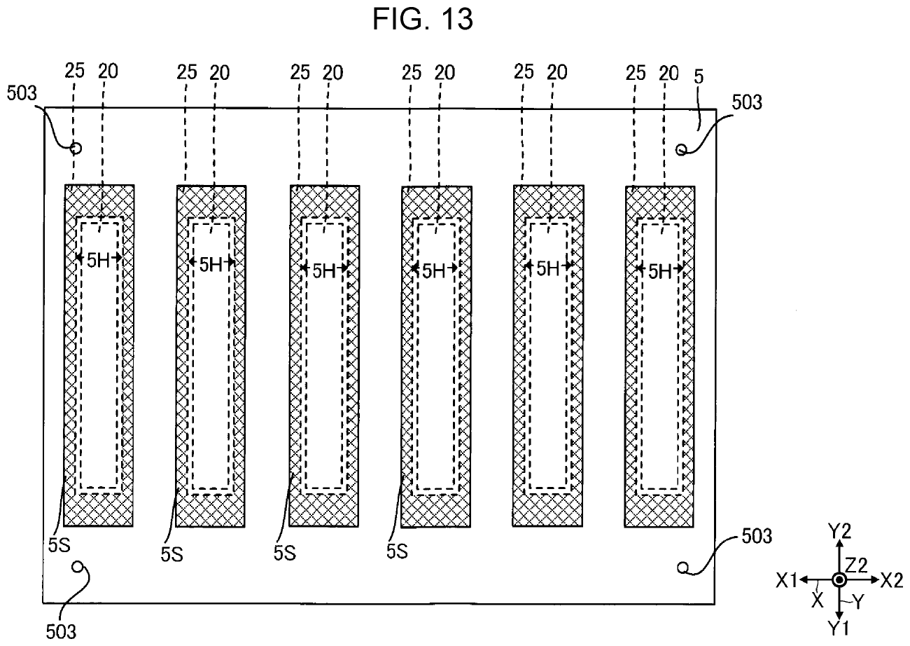

FIG. 13 shows the top view of the cover 5 shown in FIG. 4. As shown in FIGS. 4 and 13, the cover 5 has the plurality of openings 5H. Each opening 5H is a hole penetrating the cover 5 in the thickness direction. Each opening 5H is provided to expose part of the head module 2 to the outside. Specifically, the chip 20 is exposed through the opening 5H. Therefore, the plurality of nozzles N is exposed through the opening 5H.

The cover 5 includes a plurality of support faces 5S. The support face 5S is a face that is part of the face 512, of the cover 5, that faces the Z2 direction, contacts the flow path opening forming member 25, and supports the flow path opening forming member 25. The support face 5S is a frame that surrounds the opening 5H of the cover 5. In FIG. 13, the support face 5S is shaded.

As shown in FIG. 4, part of the face 251, of the aforementioned flow path opening forming member 25, that faces the Z1 direction has the supported face 2511. The supported face 2511 is a face that contacts the support face 5S of the cover 5 and is supported by the support face 5S. The head module 2 is held by the cover 5 when the supported face 2511 contacts the support face 5S.

The flow path opening forming member 25, not the chip 20, is held by the cover 5, so that the chip 20 can be positioned within the opening 5H of the cover 5. This avoids excessively exposing the chip 20 in the Z1 direction of the cover 5. Hence, it is possible to suppress an increase in the distance between the chip 20 and the medium 90, that is, the paper gap.

A thickness D5 of the cover 5 in the Z1 direction is thicker than the thickness D2 of the chip 20 in the Z1 direction. This reduces the possibility of deformation of the cover 5 due to the reaction force of the sealing member 4.

Furthermore, the nozzle face SN of the chip 20 and the face 511, of the cover 5, that faces the Z1 direction are generally flush. This suppresses an increase in the paper gap. Furthermore, it is easy to wipe the face 511, of the cover 5, that faces the Z1 direction and the nozzle face SN in a batch. The nozzle face SN and the face 511, of the cover 5, that faces the Z1 direction are generally flush means not only that they are completely flush, but also that there are steps to the extent that manufacturing errors and the like are included. The nozzle face SN and the face 511, of the cover 5, that faces the Z1 direction do not have to be generally flush.

As shown in FIG. 4, the cover 5 has a plurality of fixing holes 503. Each of the 503 fixing holes is used to fix the cover 5 to the holder 6. As shown in FIG. 4, each fixing hole 503 is provided in the face 512, of the cover 5, that faces the Z2 direction. Each fixing hole 503 is a bottomed hole provided in the face 512, of the cover 5, that faces the Z2 direction. Each fixing hole 503 is a recess provided in the face 512, of the cover 5, that faces the Z2 direction, that can be regarded as a depression formed in the face 512. The plurality of fixing holes 503 correspond, on a one-to-one basis, to and overlaps the aforementioned plurality of fixing holes 652H when viewing the Z1 direction.

One cover 5 described above is provided for one holder 6, but a plurality of covers may be provided for one holder 6. For example, the cover 5 holding three of the six head modules 2 and the cover 5 holding the remaining 3 head modules 2 may be provided.

For example, two or more head modules 2 to be replaced at the similar timing are held together by one cover 5. This facilitates work because two or more head modules 2 to be replaced at the similar timing can be replaced together.

Specifically, for example, the cover 5 preferably holds the plurality of head modules 2 that ejects the same type of liquid among the plurality of head modules 2. This allows chips that have a similar service life, such as chips for colors that are frequently discharged, to be replaced together. This improves work efficiency in replacement. Two or more head modules 2 held in one cover 5 do not have to eject the same type of ink. One head module 2 may be capable of ejecting one type of ink or more than one type of ink.

### 1-3E. Fixing Member Group 150

As shown in FIG. 4, a fixing member group 150 includes a plurality of fixing members 155 and a plurality of fixing members 157.

The fixing member 155 fixes the holder 6 and the cover 5. The fixing member 155 is inserted into the fixing hole 652H, which is a through hole, and the recess-shaped fixing hole 503 in this order. Therefore, the fixing member 155 is not exposed to the nozzle face SN. On the other hand, part of the fixing member 155 is exposed to the face 606, of the holder 6, that faces the Z2 direction.

The fixing member 157 directly fixes the holder 6 and the head module 2. The fixing member 157 is inserted into the fixing hole 651H, which is a through hole, and the recess-shaped fixing hole 215 in this order. Therefore, the fixing member 157 is not exposed to the nozzle face SN. On the other hand, part of the fixing member 157 is exposed to the face 606, of the holder 6, that faces the Z2 direction.

The fixing members 155 and 157 are not exposed to the nozzle face SN, so that it is possible to avoid the adhesion and solidification of ink mist on the fixing members 155 and 157. Therefore, it is possible to prevent mist adhesion from making it difficult to remove the fixing members 155 and 157.

As shown in FIG. 10, the plurality of fixing members 155 is provided near the corners of the holder 6, which is, for example, square-shaped when viewing the Z1 direction. The plurality of 157 fixing members is provided in in units of the head module 2. Specifically, the two fixing members 157 are provided for each head module 2. One of the two fixing members 157 is disposed in the Y1 direction of the head module 2 when viewing the Z1 direction, and the other is disposed in the Y2 direction of the head module 2.

Each of the fixing members 155 and 157 is preferably a screw. In this case, for example, wall faces forming the fixing hole 651H, the fixing hole 652H, the fixing hole 215, and the fixing hole 503 form female screws. The fixing members 155 and 157 are screws, so that the cover 5 and a plurality of head module 2 can be easily unfixed from the holder 6 by rotating and undoing the screws. The fixing members 155 and 157 are screws, so that the plurality of head modules 2 and covers 5 can be attached to and removed from the holder 6 at will, without using an adhesive.

The fixing members 155 and 157 may be other than screws. For example, the fixing members may have a configuration that includes an L- or T-shaped pin with its tip in the Z1 direction bent at a right angle and an elastic member such as a plate spring or a coil spring, and fixes the holder 6 and the cover 5 to each other using the elastic force of the elastic member.

Thus, the fixing member 155 can be of any configuration as long as it is a member that fixes the holder 6 and the cover 5 to each other. The fixing member 157 can be of any configuration as long as the fixing member is a member that fixes the holder 6 and the head module 2 to each other.

### 1-3F. Circuit Board 7, Relay Board 70 and Connector 71

As shown in FIG. 3, the circuit board 7 is provided for each head module 2. The circuit board 7 is inserted into the wiring hole 25H of the chip 20 and the wiring hole 20H of the flow path opening forming member 25. The relay board 70 is electrically coupled to the plurality of head module 2. The circuit board 7 is joined to the vibration plate 204. The circuit board 7 protrudes in the Z2 direction from the vibration plate 204. The circuit board 7 is a mounting component with a plurality of wires formed to electrically couple the chip 20 to the relay board 70. The circuit board 7 includes, for example, a flexible substrate such as a flexible printed circuit (FPC) or a chip on film (COF) or a rigid substrate. The drive signal and the reference voltage for driving the drive element E are supplied to each drive element E from the circuit board 7.

The relay board 70 is fixed to the bottom face of the recess 610 of the face 605, of the flat plate portion 61 of the holder 6, in the Z1 direction. The relay board 70 is flat and is fixed to the holder 6 with an adhesive or the like. The relay board 70 is electrically coupled to the control unit 91. A plurality of connectors 71 is mounted on the relay board 70. The plurality of connectors 71 is provided on the plurality of circuit boards 7 on a one-to-one basis. The end, of the circuit board 7, with a plurality of terminals is removably inserted into each connector 71. The circuit board 7 is preferably rigid to facilitate insertion and removal of the end of the circuit board 7 into and from the connector 71. When the circuit board 7 is composed of a flexible substrate, it is desirable to attach a rigid body for supporting the flexible substrate. By inserting the end of the circuit board 7 into the connector 71, the circuit board 7 is electrically coupled to the control unit 91 via the relay board 70.

### 1-3G. Bushing

As shown in FIG. 4, the bushing 526 is disposed between the flow path opening forming member 25 and the cover 5. Although not shown in detail, for example, the bushings 526 are provided in the Y1 direction and the Y2 direction of each flow path opening forming member 25 when viewing the Z1 direction. The bushing 522 is disposed between the holder 6 and the cover 5. Although not shown in detail, for example, the bushing 522 is disposed in a rectangular frame along the outer edge of the holder 6 when viewing the Z1 direction. Each of the bushings 526 and 522 is, for example, an elastic resin material. The bushings 526 and 522 are provided, so that it is possible to reduce the possibility of ink mist or other substances entering the housing space in the recess 610 of the holder 6 from the outside of the liquid ejecting head 1.

### 1-4. Method of Manufacturing Liquid Ejecting Head 1

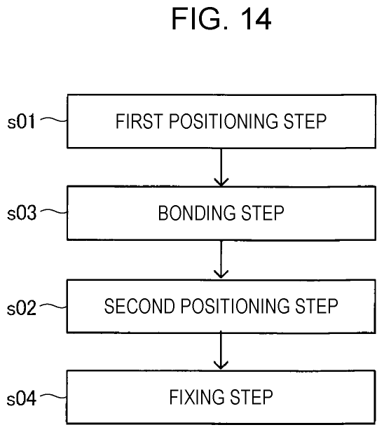

FIG. 14 is a flow diagram showing part of the method of manufacturing the liquid ejecting head 1 of the first embodiment. As shown in FIG. 14, the method of manufacturing the liquid ejecting head 1 includes a first positioning step s01, a bonding step s03, a second positioning step s02, and a fixing step s04 in this order. The head module 2 is manufactured by attaching the chip 20 to the flow path opening forming member 25 in the first positioning step s01 and the bonding step s03. The head module 2 is attached to the holder 6 in the second positioning step s02 and the fixing step s04.

The first positioning step S01 and the second positioning step S02 are provided, so that it is possible to achieve alignment of the plurality of head modules 2, especially alignment of nozzles N between the plurality of head modules 2 with high precision.

### 1-4A. First Positioning Step s01

In the first positioning step s01, the chip 20 and the flow path opening forming member 25 are positioned. Specifically, the nozzle plate 201 of the chip 20 and the flow path opening forming member 25 are optically positioned with respect to any nozzle N of the plurality of nozzles N.

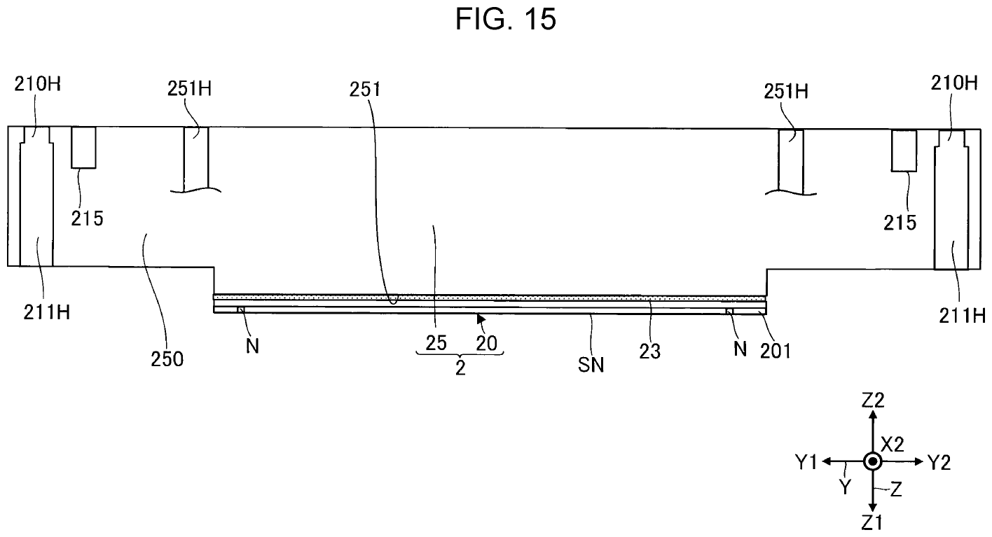

Each of FIGS. 15, 16, and 17 is a diagram for describing the first positioning step s01 shown in FIG. 14. In the first positioning step s01, the nozzle plate 201 and the flow path opening forming member 25 are positioned by positioning the relative positions of the first positioning portion 210H and the nozzle N with respect to a predetermined nozzle N. In FIGS. 15, 16, and 17, the predetermined nozzle N of the plurality of nozzles N is shown in a simplified manner.

As shown in FIG. 15, in the first positioning step s01, first, for example, a thermosetting adhesive 23 is applied to the face 251, of the flow path opening forming member 25, that faces the Z1 direction, and then the chip 20 is brought into contact with the adhesive 23. In this case, the nozzle plate 201 of the chip 20 is positioned away from the adhesive 23.

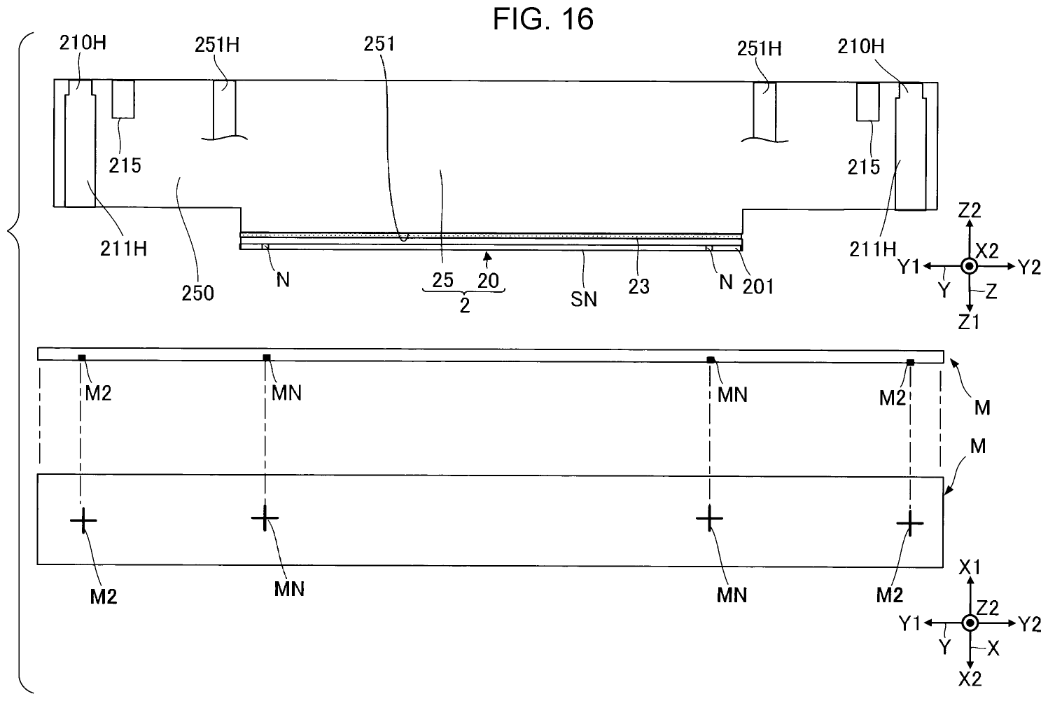

Next, as shown in FIG. 16, a translucent mask M is disposed in the Z1 direction of the chip 20 with being away from the chip 20. The mask M is, for example, a plate-shaped member with visible light transmission of 70% or more. The mask M is made of a light-transmitting material such as glass, for example.

The mask M has a mark MN corresponding to a predetermined nozzle N and a mark M2 corresponding to the first positioning portion 210H. The marks MN and M2 are provided at the positions where the distance between the predetermined nozzle N and the first positioning portion 210H is a desired distance. The marks MN and M2 have light-shielding with visible light transmission of 70% or less so that they can be imaged.

Each of the mark MN and the mark M2 is provided in plurality from the viewpoint of improving positioning accuracy. In the shown example, two marks MN and two marks M2 are provided on the mask M. Furthermore, the two marks MN and the two marks M2 is preferably aligned in a straight line from the viewpoint of improving positioning precision. The respective number and the arrangement of the marks MN and M2 are not limited to the example shown in the figure.

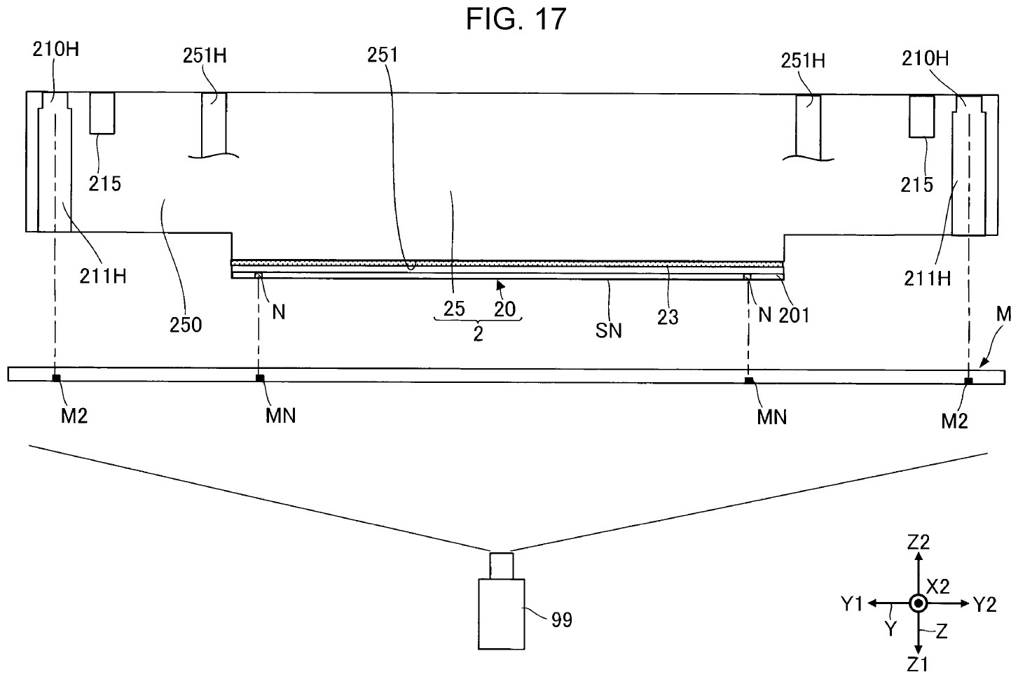

Next, as shown in FIG. 17, the two marks MN and the two marks M2 of the mask M, and the two predetermined nozzles N of the nozzle plate 201 and the two first positioning portions 210H of the flow path opening forming member 25 are positioned using an imaging unit 99. Each of the two predetermined nozzles N of the nozzle plate 201 and the two first positioning portions 210H of the flow path opening forming member 25 serve as alignment marks for positioning.

The imaging unit 99 is disposed away from the chip 20 in the Z1 direction of the chip 20 with the mask M disposed therebetween. Therefore, the mask M is disposed between the imaging unit 99 and the chip 20. The mask M and the imaging unit 99 are away from each other.

The imaging unit 99 includes, for example, a camera including an imaging element such as a CMOS image sensor or CCD image sensor and a condensing lens that collects and condenses light onto the imaging element. The two marks MN and the two marks M2 of the mask M are optically positioned with the two predetermined nozzles N and the two first positioning portions 210H using the imaging unit 99.

Specifically, using an image and the like captured by the imaging unit 99, the two predetermined nozzles N and the two first positioning portions 210H that are the plurality of alignment marks, and the plurality of marks of the mask M is superimposed with each other. As a result, the chip 20 and the flow path opening forming member 25 are positioned with respect to the nozzle N. The first positioning portion 210H is imaged through the through hole 211H. In the shown example, one camera capable of capturing the entire mask M is shown as the imaging unit 99, but the imaging unit 99 may include a plurality of cameras positioned at respective locations facing the plurality of alignment marks.

According to the first positioning step s01 described above, the chip 20 and the flow path opening forming member 25 can be positioned with high precision with respect to the nozzle N.

As mentioned above, in the first positioning step s01, the chip 20 and the flow path opening forming member 25 are positioned by positioning the relative positions of the first positioning portion 210H and the nozzle N using the first positioning portion 210H as an alignment mark.

The first positioning portion 210H is used to position the head module 2 and the holder 6 in the second positioning step s02 described below. Therefore, by using the first positioning portion 210H used in the second positioning step s02 as an alignment mark in the first positioning step s01, no other alignment mark is required in the first positioning step s01. Furthermore, by using the same first positioning portion 210H in the first positioning step s01 and second positioning step s02, the positioning precision of the chip 20, the flow path opening forming member 25, and the holder 6 can be improved.

In the first positioning step s01, another alignment mark may be provided at the flow path opening forming member 25 without using the first positioning portion 210H as an alignment mark.

As mentioned above, in the first positioning step s01, the first positioning portion 210H and the nozzle N are optically detected by the imaging unit 99 located in the Z1 direction where the nozzle N opens for the nozzle plate 201 and the flow path opening forming member 25. According to such a method, the nozzle plate 201 and the flow path opening forming member 25 can be easily positioned with high precision with respect to the nozzle N.

Specifically, the first positioning portion 210H is optically detected through the through hole 211H that opens to the face 251, of the flow path opening forming member 25, that faces the Z1 direction. As mentioned above, the through hole 211H is disposed in the Z1 direction of the first positioning portion 210H and communicates with the first positioning portion 210H, and has a larger outer shape than the first positioning portion 210H. Such a through hole 211H is provided, so that it is easy to optically detect the position of the first positioning portion 210H through the through hole 211H.

As shown in FIG. 8, the depth D21 of the through hole 211H is deeper than the depth D20 of the first positioning portion 210H. In other words, the depth D20 is shallower than the depth D21. This allows positioning to be made with high precision. It is easy to attach and detach the second positioning portion 654 to and from the first positioning portion 210H when the depth D20 is shallower than the depth D21, compared with when the depth D20 is deeper than D21.

The first positioning portion 210H does not overlap the chip 20 when viewing the Z1 direction. Thus, the nozzle N and the first positioning portion 210H do not overlap with each other when viewing the Z1 direction. Therefore, it is possible to position the chip 20 and the flow path opening forming member 25 from below the chip 20 using the nozzle N and the first positioning portion 210H as alignment marks.

### 1-4B. Bonding Step s03

In the bonding step s03, after the first positioning step s01, the adhesive 23 for fixing the chip 20 and the flow path opening forming member 25 is cured. For example, when the adhesive 23 is a thermosetting resin, heat is applied to cure the adhesive 23.

In the present embodiment, the bonding step s03 is performed between the first positioning step s01 and the second positioning step s02. After the first positioning step s01, the chip 20 and the flow path opening forming member 25 are bonded, so that it is possible to improve positioning precision of the chip 20 with nozzle N and the flow path opening forming member 25. Thus, for example, the positioning of the wiring hole 20H and the wiring hole 25H, and the positioning of the space Rc and the communication space Ra can be made with high precision.

### 1-4C. Second Positioning Step s02

In the second positioning step s02, the head module 2 and the holder 6 are positioned. Specifically, the head module 2 and the holder 6 are positioned by press fitting the second positioning portion 654 of the holder 6 into the first positioning portion 210H of the flow path opening forming member 25.

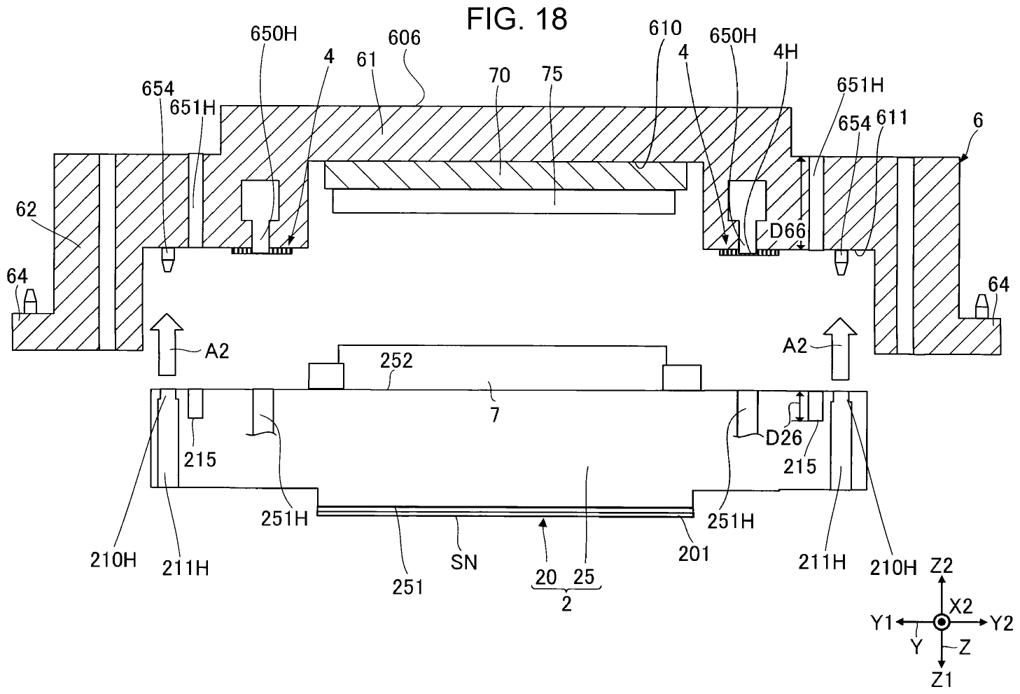

FIG. 18 is a diagram for describing the second positioning step s02 shown in FIG. 14. In the second positioning step s02, the head module 2 is brought closer to the holder 6 as shown by an arrow A2. The second positioning portion 654 is then press-fitted into the first positioning portion 210H. This allows positioning of the head module 2 and the holder 6.

When the second positioning portion 654 is press-fitted into the first positioning portion 210H, the sealing member 4 is interposed between the head module 2 and the holder 6. In this case, for example, the sealing member 4 is disposed so that the communication port 4H of the sealing member 4 overlaps the flow path opening 650H that the holder 6 has when viewing the Z1 direction. When the second positioning portion 654 is press-fitted into the first positioning portion 210H, the circuit board 7 is inserted into the connector 71.

### 1-4D. Fixing Step s04

In the fixing step s04, the head module 2 is attached to the holder 6. Specifically, the fixing member 157 is inserted into the fixing hole 651H and the fixing hole 215 in this order. When the fixing member 157 is a screw, the head module 2 is fixed to the holder 6 by being screwed by the fixing member 157.

In the above method, the chip 20 is attached to the flow path opening forming member 25 and the head module 2 is attached to the holder 6.

As mentioned above, the method of manufacturing the liquid ejecting head 1 includes the first positioning step s01 and the second positioning step s02. Since the chip 20 and the flow path opening forming member 25 are positioned with respect to the nozzle N in the first positioning step s01, the head module 2 and the holder 6 are positioned with respect to the nozzle N simply by press fitting the flow path opening forming member 25 into the holder 6. This improves positioning precision of each head module 2 with respect to the holder 6. Furthermore, the nozzle alignment between the plurality of head modules 2 can be made with high precision. Therefore, when some of the head modules 2 of the plurality of head modules 2 of the liquid ejecting head 1 need to be replaced with other head modules 2 due to malfunction or other reasons, nozzle alignment between the plurality of head modules 2 can be ensured with high-precision simply by press-fitting the flow path opening forming member 25 into the holder 6. Therefore, the work to replace the head module 2 to achieve regeneration can be easily performed.

As mentioned above, the direction in which one of the first positioning portion 210H and the second positioning portion 654 is press-fitted into the other is the same as the direction in which the flow path opening 650H and the flow path opening 251H overlap with each other. Therefore, by attaching the head module 2 to the holder 6, the flow-path-communication between the flow path 6R and the flow path 25R can be easily made with high precision.

The plurality of second positioning portions 654 is disposed at the bottom of the first recess 611. The first positioning portion 210H is disposed at the face 252, of the cover 5, that faces the Z2 direction, which is opposite to the Z1 direction. The first positioning portion 210H and the second positioning portion 654 are positioned in this manner, so that only the head module 2 to be replaced can be easily attached and detached from below the holder 6.

As shown in FIG. 4, the fixing member 157 is disposed so that the fixing member does not overlap the chip 20 and sandwiches the sealing member 4 between the fixing member 157 and the chip 20 when viewing the Z1 direction. The fixing member 157 does not overlap the chip 20 when viewing the Z1 direction, so that it is unlikely that the chip 20 is subjected to the load generated by fixing the fixing member 157 in the fixing step s04, compared with the case where the fixing member overlaps the chip. Furthermore, the sealing member 4 is disposed between the fixing member 157 and the chip 20 when viewing the Z1 direction, so that the distance of the chip 20 to the fixing member 157 can be made farther by the thickness of the sealing member 4. As a result, it is unlikely that the chip 20 is subjected to the load generated by fixing the fixing member 157.

### 2. Second Embodiment

The second embodiment of the present disclosure is described below. In the following examples, elements whose actions or functions are the same as those of the first embodiment will be abbreviated using the same symbols as those used in the description of the first embodiment, and detailed descriptions of each will be omitted as appropriate.

### 2-1. Method of Manufacturing Liquid Ejecting Head 1

The method of manufacturing the liquid ejecting head 1 in the present embodiment is a method of removing a head module 2 of a certain liquid ejecting head 1, repairing the head module 2, and manufacture a new liquid ejecting head 1 including the repaired head module 2. In the following, a certain liquid ejecting head 1 will be referred to as “a first liquid ejecting head 1a” and a new liquid ejecting head 1 will be referred to as “a second liquid ejecting head 1b.

Specifically, the method of manufacturing the liquid ejecting head 1 in the present embodiment includes removing a specific head module 2 from a certain holder 6, manufacturing a new head module 2 by repairing that specific head module, and then installing the new head module 2 in another holder 6.

In the following, a certain holder 6 is referred to as “a first holder 6a” and a plurality of head modules 2 attached to the first holder 6a is referred to as “a first head module 2a”. The specific head module 2 above is one or more of the plurality of first head modules 2a. Another new holder 6 is referred to as “a second holder 6b” and the plurality of head modules 2 attached to the second holder 6b is referred to as “a second head modules 2b”. The new head module 2 obtained by replacing the first head module 2a is the second head module 2b. The chip 20 of the first head module 2a is referred to as “a first chip 20a” and the nozzle plate 201 of the first chip 20a is referred to as “a first nozzle plate 201a. The chip 20 of the second head module 2b is referred to as “a second chip 20b” and the nozzle plate 201 of the second chip 20b is referred to as “a second nozzle plate 201b”.

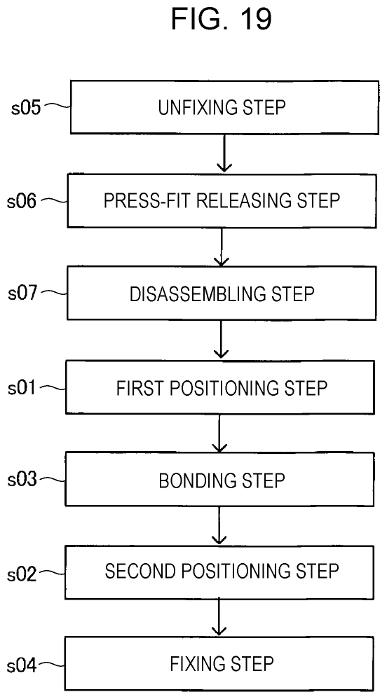

FIG. 19 is a flow diagram showing part of the method of manufacturing the liquid ejecting head 1 in the second embodiment. As shown in FIG. 19, the method of manufacturing the liquid ejecting head 1 in the present embodiment includes an unfixing step s05, a press-fit releasing step s06, a disassembling step s07, a first positioning step s01, a bonding step s03, a second positioning step s02, and a fixing step s04.

### 2-1A. Unfixing Step s05

In the unfixing step s05, the first holder 6a and the first head module 2a of the first liquid ejecting head 1a are unfixed. Specifically, the first holder 6a and the first head module 2a can be unfixed by removing the fixing member 157 from the fixing hole 651H and the fixing hole 215. Before the unfixing step s05, the cover 5 should be removed from the first holder 6a.

### 2-1B. Press-Fit Releasing Step s06

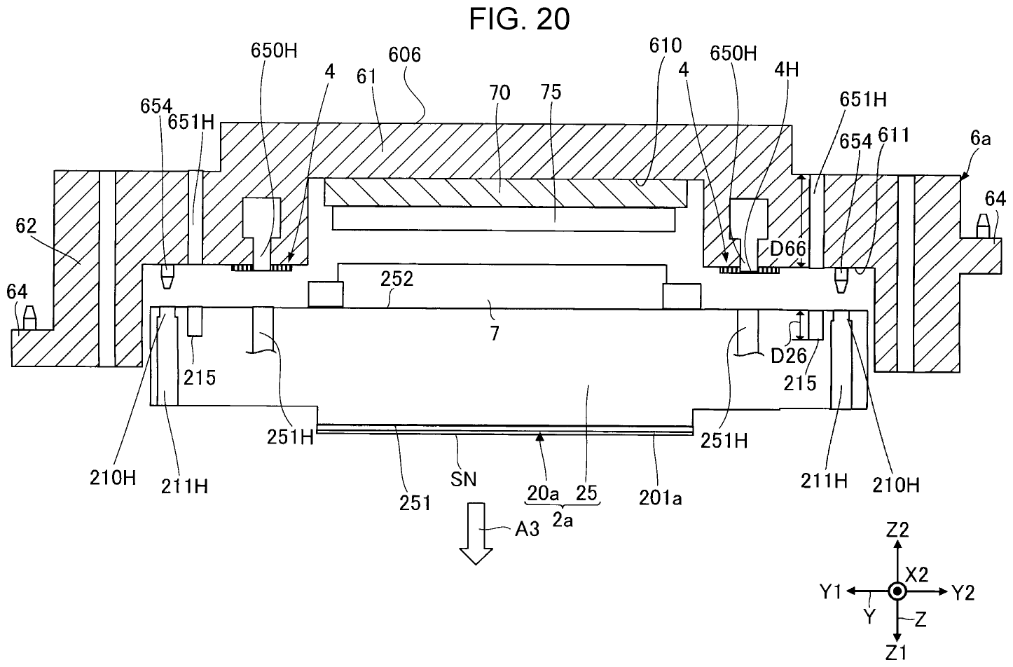

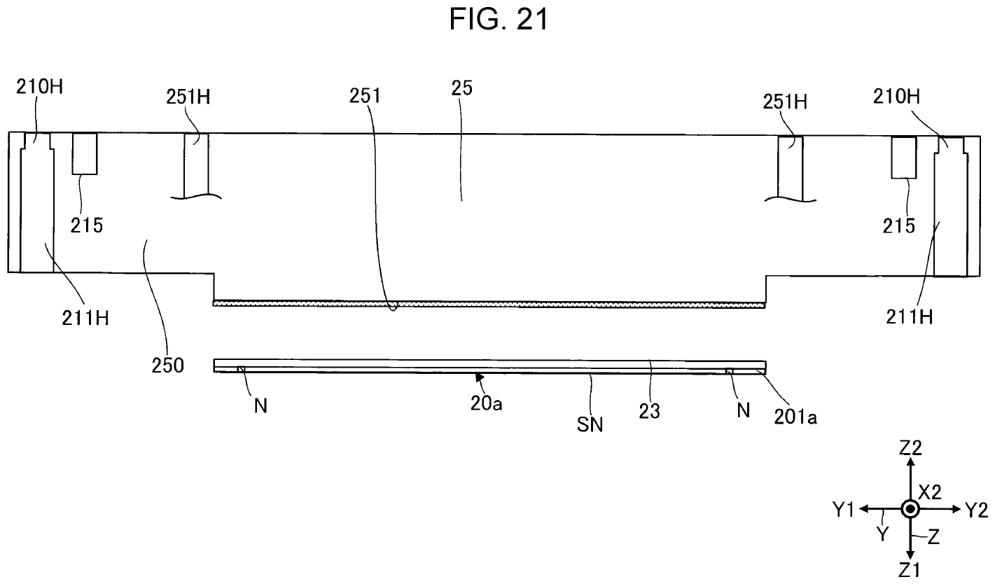

FIG. 20 is a diagram for describing the press-fit releasing step s06 shown in FIG. 19. As shown in FIG. 20, in the press-fit releasing step s06, the state of press-fit of the second positioning portion 654 of the first holder 6a into the first positioning portion 210H of the first head module 2a is released. The operator grasps the first head module 2a and pulls it downward in the direction indicated by an arrow A3 to release the above press fit, so that the first head module 2a is removed from the first holder 6a. For example, after removing the fixing member 157

from the fixing hole 651H and the fixing hole 215, a long bar-shaped member is inserted into the fixing hole 651H and the fixing hole 215, and the first head module 2a is pressed in the Z1 direction with the member. This allows easy release of the press fit of the first head module 2a into the first holder 6a. In other words, by using the fixing hole 651H as a hole for releasing the press-fit, the press-fit of the first head module 2a into the first holder 6a can be easily released. The depth of the fixing hole 651H is deeper than the depth of the fixing hole 215. This makes it easy to remove the flow path opening forming member 25 from the holder 6.

The relay board 70 is disposed in the Z2 direction of the plurality of head modules 2. The first positioning portion 210H is provided at the face 252, of the flow path opening forming member 25, that faces the Z2 direction. This makes it easy to attach and detach the first head module 2a and the circuit board 7 to be replaced from below the first holder 6a and the relay board 70. Hence, the electrical disconnection of the first head module 2a other than the component to be replaced is not necessary, simplifying the attachment and detachment process.

The press-fit state refers to a tight fit or intermediate fit, where the second positioning portion 602 is in contact with the first positioning portion 502 at least two points upon completion of insertion of the second positioning portion 602 into the first positioning portion 502. Before press fitting, the length of the longest line segment linking two points on the outer circumference of the second positioning portion 602, which is the positioning pin, is larger than the diameter of the largest circle inscribed in the first positioning portion 502, which is the positioning hole when viewing the direction along the Z axis. In the press-fit state, the head module 2 is fitted to the holder 6 by the force caused by the press fit to the extent that the head module does not fall under its own weight.

### 2-1C. Disassembling Step s07

FIG. 21 is a diagram for describing the disassembling step s07 shown in FIG. 19. As shown in FIG. 21, in the disassembling step s07, the first chip 20a and the flow path opening forming member 25 of the first head module 2a are disassembled. In other words, the first chip 20a with the first nozzle plate 201a is removed from the flow path opening forming member 25. For example, when the adhesive 23 is a thermosetting resin, a release agent or the like is used for removing the adhesive 23. When the adhesive 23 is a thermoplastic resin, heat treatment is applied to the adhesive 23 by a heater (not shown) to soften the adhesive 23, thereby separating the first chip 20a from the flow path opening forming member 25.

### 2-1D. First Positioning Step s01

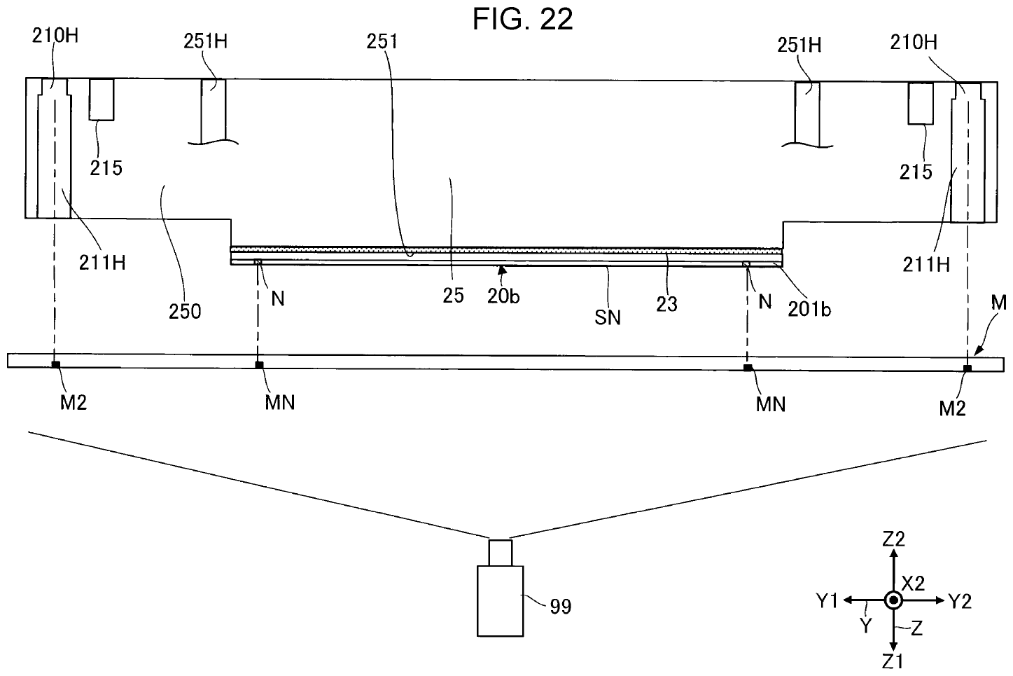

FIG. 22 is a diagram for describing the first positioning step s01 shown in FIG. 19. As shown in FIG. 22, in the first positioning step s01 of the present embodiment, the flow path opening forming member 25 separated from the first chip 20a in the disassembling step s07 and the second chip 20b including at least the second nozzle plate 201b that is different from the first nozzle plate 201a are optically positioned with respect to the nozzle N of the second nozzle plate 201b. In other words, the second nozzle plate 201b and the flow path opening forming member 25 are optically positioned with respect to the nozzle N.

The positioning method is the same as that in the first embodiment. Specifically, as shown in FIG. 22, the mask M and the imaging unit 99 are used for such positioning. Therefore, even in a case of the second chip 20b including the new second nozzle plate 201b, the positioning of the second chip 20b and the flow path opening forming member 25 can be performed with high precision.

The bonding step s03 in the present embodiment is the same as the bonding step s03 in the first embodiment. In the bonding step s03 of the present embodiment, the second chip 20b and the flow path opening forming member 25 are bonded by the adhesive 23. As a result, the second head module 2b including the second chip 20b and the flow path opening forming member 25 is generated.

### 2-1E. Second Positioning Step s02

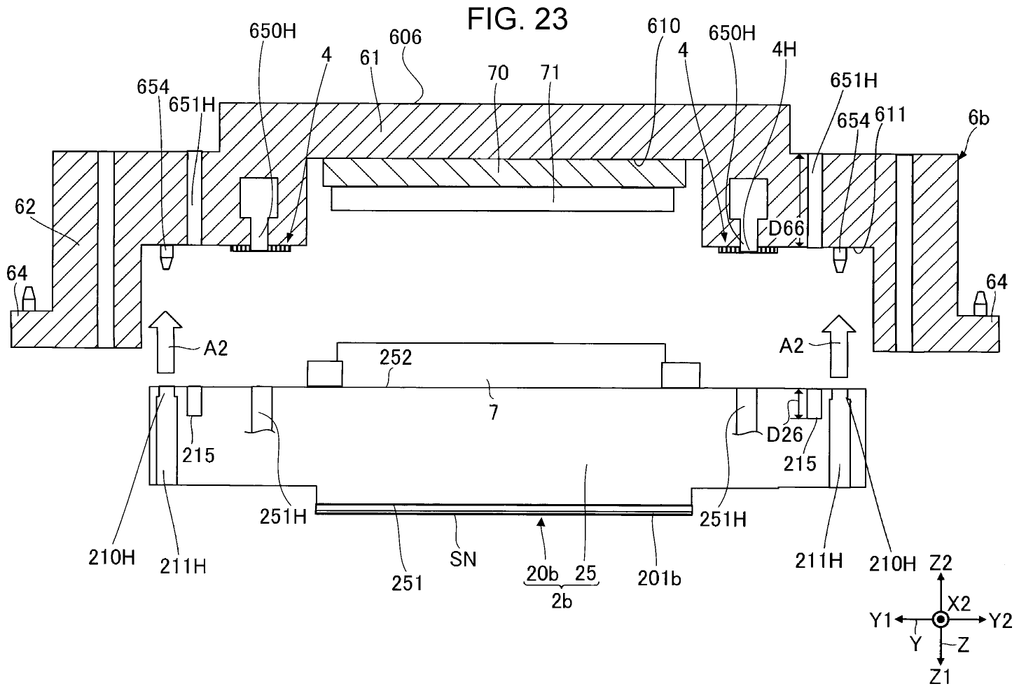

FIG. 23 is a diagram for describing the second positioning step s02 shown in FIG. 19. As shown in FIG. 23, in the second positioning step s02, the second head module 2b and the second holder 6b are positioned by press fitting the second positioning portion 654 of the new second holder 6b that is different from the first holder 6a into the first positioning portion 210H of the flow path opening forming member 25 of the second head module 2b.

Since the second chip 20b and the flow path opening forming member 25 are positioned with respect to the nozzle N in the first positioning step s01, the second head module 2b and the second holder 6b are positioned with respect to the nozzle N simply by press fitting the flow path opening forming member 25 into the second holder 6b. Therefore, nozzle N alignment with high precision between the plurality of second head modules 2b can be ensured simply by press-fitting the flow path opening forming member 25 into the second holder 6b. Therefore, the replacement of the liquid ejecting head 1 can be facilitated using the head module 2 that has been repaired by reusing the flow path opening forming member 25.

Next, the second head module 2b is fixed to the second holder 6b by the fixing step s04 same as that in the first embodiment.

The first holder 6a may be an example of “a second holder”. In other words, the first holder 6a and the second holder 6b described above may be the same holder 6. Specifically, the second head module 2b that is manufactured by repairing the first head module 2a removed from the first holder 6a of the first liquid ejecting head 1a by the unfixing step s05 to the bonding step s03 may be positioned and fixed to the first holder 6a of the liquid ejecting head 1a in the second positioning step s02 and the fixing step s04 to manufacture the second liquid ejecting head 1b.

According to the method described above, the second liquid ejecting head 1b can be manufactured from the first liquid ejecting head 1a. From another viewpoint, according to the method described above, the liquid ejecting head 1 can be reused in the form of reusing the flow path opening forming member 25.

The flow path opening forming member 25 is preferably made of metal. It is easy to repeatedly use the flow path opening forming member 25 when the flow path opening forming member 25 is made of metal, compared with when the flow path opening forming member 25 is made of resin.

### 3. Modifications

The first embodiment shown above can be modified in various ways. Specific aspects of the modifications that may be applied to the aforementioned first embodiment are described below. Two or more aspects optionally selected from the following exemplifications can be appropriately merged within a range not inconsistent with each other.

### 3-1. First Modification

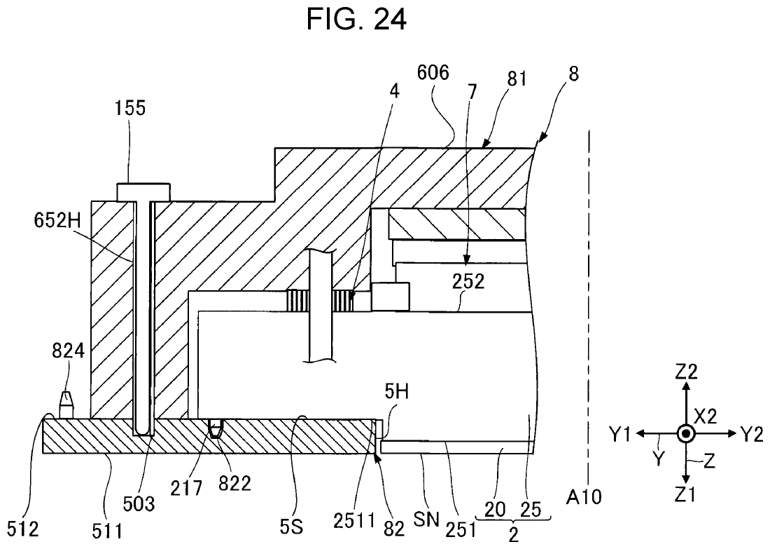

FIG. 24 is a cross-sectional view of part of the liquid ejecting head 1 of the first modification. The first modification of the liquid ejecting head 1 shown in FIG. 24 includes a holder 8. The holder 8 includes a first holder 81 and a second holder 82. The first holder 81 is almost the same as the holder 6 of the first embodiment, except that the flange 64 is omitted.

The second holder 82 is the same as the cover 5 of the first embodiment except for the following element. The second holder 82 has a portion extending in the Y1 direction or the Y2 direction of the first holder 81 when viewing the Z1 direction. The extending portion has a fourth positioning portion 824. The fourth positioning portion 824 has the same configuration as the fourth positioning portion 642 of the first embodiment and is press-fitted into the third positioning portion 102 of the unit base 11.

The second holder 82 includes a plurality of second positioning portions 822. The two second positioning portions 822 are provided for each head module 2. Although not shown in detail, one of the two second positioning portions 822 is located in the Y1 direction of the chip 20 when viewing the Z1 direction, and the other is located in the Y2 direction. The second positioning portion 822 is a hole opening in the face 512, of the second holder 82, that faces the Z2 direction. The second positioning portion 822 is a recess formed in the face 512, of the second holder 82, that faces the Z2 direction, and can also be said to be a depression in the face 512.

The head module 2 includes a first positioning portion 217 corresponding to the second positioning portion 822. The first positioning portion 217 is a projection protruding from the face 251, of the flow path opening forming member 25, that faces the Z1 direction toward the Z1 direction. The first positioning portion 217 is press-fitted into the second positioning portion 822. This positions the head module 2 to the holder 8 including the second holder 82.

For example, the second holder 82 and each head module 2 are fixed with an adhesive or the like. When the second holder 82 and each head module 2 are fixed with an adhesive, for example, in a case in which they can be separated by melting the adhesive with heat, it can be said that the second holder 82 and each head module 2 are removably fixed to each other.

In the modification of the liquid ejecting head 1, in the first positioning step s01, the first positioning portion 217 disposed at the face 251, of the flow path opening forming member 25, that faces the Z1 direction and the nozzle N that opens to the nozzle face SN, the nozzle face, of the nozzle plate 201 of the chip 20, that faces the Z1 direction can be optically detected by an imaging unit located in the Z1 direction of the nozzle plate 201 and the flow path opening forming member 25, so that it is possible to easily optically position the nozzle plate 201 and the flow path opening forming member 25 with reference to the nozzle N with high precision.

### 3-2. Other Modifications

For example, the holder 6 may have a dedicated through hole for releasing the press-fit between the first positioning portion 210H and the second positioning portion 654. For example, the through hole may be a hole with an opening area larger than the opening area of the fixing hole 651H.

In the foregoing description, the sealing member 4 is provided for each head module 2, but the sealing member 4 may be integrated with and shared by the plurality of head modules 2.

“The first positioning portion” and “the second positioning portion” are not limited to have the configurations of the embodiments and the modification described above, as long as one is press-fitted into the other. Therefore, in each of the aforementioned embodiments, “the second positioning portion” is configured to be press-fitted into “the first positioning portion”, but “the first positioning portion” may be configured to be press-fitted into “the second positioning portion”.

“The liquid ejecting apparatus” can be used in various devices such as facsimile machines, copy machines, and the like, in addition to devices dedicated to printing. The application of the liquid ejecting apparatus is not limited to printing. For example, the liquid ejecting apparatus that ejects a solution of a coloring material is used as a manufacturing apparatus that forms a color filter of a display device such as a liquid crystal display panel. The liquid ejecting apparatus that ejects a solution of a conductive material is used as a manufacturing apparatus that forms wiring and electrodes of a relay board. The liquid ejecting apparatus that ejects a solution of an organic substance relating to a living body is used as a manufacturing apparatus that manufactures a biochip, for example.

Although the present disclosure is described above based on suitable embodiments, the present disclosure is not limited to the aforementioned embodiments. The configuration of each part of the present disclosure can be replaced with any configuration that performs the functions same as those of the aforementioned embodiments, and any configuration can be added.

What is claimed is:

1. A method of manufacturing a liquid ejecting head including a plurality of head modules each having a chip including at least a nozzle plate in which a plurality of nozzles is formed and a flow path opening forming member, and a holder holding the plurality of head modules, the method comprising:
a first positioning step of optically positioning the nozzle plate and the flow path opening forming member with reference to the nozzles; and
a second positioning step of positioning the head module and the holder by press fitting one of a first positioning portion of the flow path opening forming member and a second positioning portion of the holder into the other of first positioning portion and the second positioning portion.

2. The method of manufacturing the liquid ejecting head according to claim 1, further comprising:
a bonding step of curing an adhesive for fixing the chip and the flow path opening forming member after the first positioning step.

3. The method of manufacturing the liquid ejecting head according to claim 1, wherein
the first positioning step includes positioning relative positions of the first positioning portion and the nozzles.

4. The method of manufacturing the liquid ejecting head according to claim 3, wherein
the first positioning step includes optically detecting the first positioning portion and the nozzles by an imaging unit located in a first direction where the nozzles open to the nozzle plate and the flow path opening forming member.

5. The method of manufacturing the liquid ejecting head according to claim 4, wherein
the first positioning step includes optically detecting the first positioning portion and the nozzles, the first positioning portion being disposed at a face, of the flow path opening forming member, that faces the first direction.

6. The method of manufacturing the liquid ejecting head according to claim 4, wherein
the first positioning portion is a positioning hole into which a positioning pin that is the second positioning portion is press-fitted, and wherein
a face, of the flow path opening forming member, that faces the first direction has a through hole that is disposed in the first direction of the positioning hole, communicates with the positioning hole, and has a larger outer shape than the positioning hole.

7. The method of manufacturing the liquid ejecting head according to claim 6, wherein
a depth of the through hole is deeper than a depth of the positioning hole.

8. A method of manufacturing a liquid ejecting head, the method comprising manufacturing a second liquid ejecting head including a second holder, a first liquid ejecting head including a plurality of first head modules and a first holder that holds the plurality of first head modules, the manufacturing including using a portion of the first head module of the first liquid ejecting head, the method comprising:
a press-fit releasing step of releasing a press-fit state in which one of a first positioning portion of the first head module and a second positioning portion of the first holder are press-fitted to the other of the first positioning portion and the second positioning portion;
a disassembling step of disassembling the first head module in which the press-fit state with the first holder is released in the press-fit releasing step into a first chip including at least a first nozzle plate in which a plurality of nozzles is formed and a flow path opening forming member including the first positioning portion;
a first positioning step of optically positioning a flow path opening forming member separated from the first chip in the disassembling step and a second chip that includes at least a second nozzle plate different from the first nozzle plate, that is, the second nozzle plate and the flow path opening forming member, with nozzles of the second nozzle plate as a reference; and
a second positioning step of positioning, by press-fitting one of the first positioning portion of the flow path opening forming member and a second positioning portion of the second holder of a second head module including the second chip and the flow path opening forming member positioned in the first positioning step into the other of the first positioning portion and the second positioning portion, the second head module and the second holder.

9. The method of manufacturing the liquid ejecting head according to claim 8, wherein
the flow path opening forming member is made of metal.
